(19) United States
(12) Patent Application Publication
(10) Pub. No.: US 2025/0101257 A1
(43) Pub. Date: Mar. 27, 2025

(54) ASPHALT COMPOSITION FOR ROOFING APPLICATIONS

(71) Applicant: CERTAINTEED LLC, Malvern, PA (US)

(72) Inventors: Xiguo ZENG, Sudbury, MA (US); Amir BAHADORI, Malvern, PA (US); Justin MINDER, Wayne, PA (US); Robert D. LIVSEY, Limerick, PA (US); Paul A. BENENSKY, Collegeville, PA (US); Travis COHEN, Marlborough, MA (US)

(21) Appl. No.: 18/891,354

(22) Filed: Sep. 20, 2024

Related U.S. Application Data
(60) Provisional application No. 63/584,391, filed on Sep. 21, 2023.

(51) Int. Cl. C09D 195/00; C03C 25/1095; C03C 25/28; C03C 25/44; C03C 25/47; C09D 7/40; C09D 7/61; C09D 7/65; E04D 1/20

(52) U.S. Cl. CPC C09D 195/00; C03C 25/1095; C03C 25/28; C03C 25/44; C03C 25/47; C09D 7/61; C09D 7/65; C09D 7/69; E04D 1/20

(57) ABSTRACT

According to one aspect, an asphalt blend can include asphalt, a first polymer additive, and carbon black. The blend can be mixed with filler to prepare a filled asphalt mix. The blends and mixes may have a particular softening point or penetration at 115° F. that may provide improved performance or durability.

### CROSS-REFERENCE TO RELATED APPLICATION(S)

This application claims priority under 35 U.S.C. § 119 (e) to U.S. Provisional Patent Application No. 63/584,391, entitled “ASPHALT COMPOSITION FOR ROOFING APPLICATIONS,” filed Sep. 21, 2023, by Xiguo ZENG et al., which is assigned to the current assignee hereof and is incorporated herein by reference in its entirety.

### BACKGROUND

### Field of the Disclosure

The following is directed to asphalt compositions, and more particularly, filled asphalt mixes for roofing applications.

### SUMMARY

Filled asphalt mixes can include filler and asphalt blends including asphalt, a polymer additive and carbon black. The blends may have a particular softening point or penetration at 115° F. that may provide improved performance or durability.

### BRIEF DESCRIPTION OF THE DRAWINGS

The present disclosure may be better understood, and its numerous features and advantages made apparent to those skilled in the art by referencing the accompanying drawings.

FIG. 1 includes a process for preparing a filled asphalt mix.

FIG. 2 is a schematic top view of a pallet useful in various embodiments of the disclosure.

FIG. 3 is a schematic side view of the pallet of FIG. 2, loaded with bundles of shingles.

FIG. 4 is a schematic bottom view of the pallet of FIG. 2.

FIG. 5 is a schematic bottom view of another pallet useful in various embodiments of the disclosure.

FIG. 6 includes a microscope image of a filled asphalt blend for image analysis.

FIGS. 7a and 7b include images of shinglets after non-adhesion testing.

### DETAILED DESCRIPTION

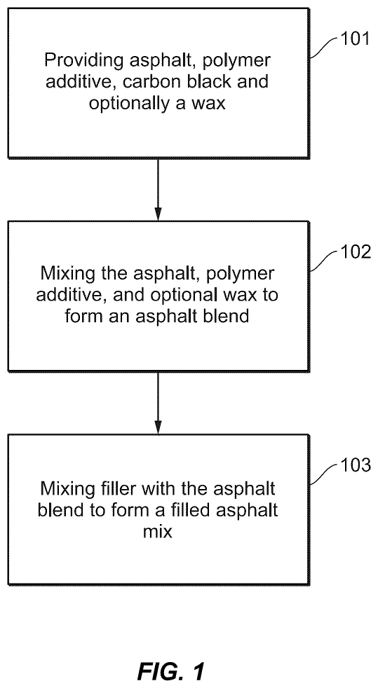

The following is directed to asphalt compositions. A process for preparing a filled asphalt mix 100 is shown in FIG. 1.

The process can begin with step 101, providing asphalt, polymer additive, and carbon black, and optionally a wax. The process can continue with step 102, mixing the asphalt, polymer additive, and carbon black, and optional wax to form an asphalt blend.

In an embodiment, mixing the asphalt blend may be done at a particular temperature that may facilitate improved performance and/or manufacturing of the asphalt mix. In an embodiment the mixing may be done at a temperature of at least 325° F. or at least 330° F. or at least 345° F. or at least 350° F. or at least 355° F. or at least 360° F. or at least 365° F. In an embodiment, mixing may be done at a temperature of no greater than 425° F. or no greater than 420° F. or no greater than 415° F. or no greater than 410° F. or no greater than 405° F. or no greater than 400° F. or no greater than 395° F. or no greater than 390° F. or no greater than 385° F. It will be appreciated that the mixing temperature may be between any of the minimum and maximum values noted above, including for example, but not limited to, at least 325° F. and not greater than 405° F. or at least 365° F. and not greater than 385° F.

In an embodiment, the asphalt may be a particular asphalt that may provide improved performance and or manufacturing of the asphalt mix. In an embodiment, the asphalt can include paving grade asphalt.

In an embodiment, the paving grade asphalt may have a particular high temperature performance grade that may provide improved performance and or manufacturing of the asphalt mix. In an embodiment, the paving grade asphalt may have a high temperature performance grade of at least 46° C. or at least 52° C. or at least 58° C. or at least 64° C. or at least 70° C. or at least 82° C. In an embodiment, the paving grade asphalt may have a high temperature performance grade of not greater than 82° C. or not greater than 76° C. or not greater than 70° C. or not greater than 64° C. or not greater than 58° C. or not greater than 52° C. or not greater than 46° C. It will be appreciated that the high temperature performance grade of the paving grade asphalt may be between any of the minimum and maximum values noted above, including for example, but not limited to at least 46° C. and not greater than 82° C. or at least 58° C. and not greater than 70° C.

In an embodiment, the paving grade asphalt may have a particular low temperature performance grade that may provide improved performance and or manufacturing of the asphalt mix. In an embodiment, the paving grade asphalt may have a low temperature performance grade at least −46° C. or at least −40° C. or at least −34° C. or at least −28° C. or at least −22° C. or at least-16° C. or at least −10° C. In an embodiment, the paving grade asphalt may have a low temperature performance grade of not greater than −10° C. or not greater than −16° C. or not greater than −22° C. or not greater than −28° C. or not greater than −34° C. or not greater than −40° or not greater than −46° C. It will be appreciated that the low temperature performance grade of the paving grade asphalt may be between any of the minimum and maximum values noted above, including for example, but not limited to at least −46° C. and not greater than −10° C. or at least −34° C. and not greater than −16° C.

In an embodiment, the paving grade asphalt can include PG 64-22 asphalt.

In an embodiment, the blend may have a particular asphalt content that may provide improved performance and/or manufacturing of the asphalt mix. In an embodiment the blend can have an asphalt content of at least 70 wt. % for a total weight of the blend or at least 72 wt. % or at least 74 wt. % or at least 76 wt. % or at least 78 wt. % or at least 80 wt. % or at least 82 wt. % or at least 84 wt. % or at least 86 wt. % or at least 88 wt. % or at least 90 wt. % or at least 92 wt. % or at least 94 wt. %. In an embodiment, the blend can have an asphalt content of no greater than 99 wt. % for a total weight of the blend or no greater than 98 wt. % or no greater than 96 wt. % or no greater than 94 wt. % or no greater than 92 wt. % or no greater than 90 wt. % or no greater than 88 wt. % or no greater than 86 wt. % or no greater than 84 wt. % or no greater than 82 wt. % or no greater than 80 wt. %. It will be appreciated that the asphalt content may be between any of the minimum and maximum values noted above, including for example, but not limited to at least 70 wt. % and not greater than 98 wt. % or at least 76 wt. % and not greater than 92 wt. %.

In an embodiment, the blend may have a particular carbon black that may provide improved performance and/or manufacturing of the asphalt mix. In an embodiment, the carbon black can be virgin carbon black, recycled carbon black, or reclaimed carbon black.

In an embodiment, the blend may include carbon black of a particular size that may provide improved performance and/or manufacturing of the asphalt mix. In an embodiment, the carbon black comprises an average cross sectional area of no greater than 600μ² or no greater than 550μ² or no greater than 500μ² or no greater than 450μ² or no greater than 400μ² or no greater than 350μ² or no greater than 300μ² or no greater than 250μ² or no greater than 200μ² or no greater than 150μ² or no greater than 100μ² or no greater than 50μ². In an alternative embodiment, the carbon black comprises an average cross sectional area of at least 1μ² or at least 5μ² or at least 10μ². It will be appreciated that the average cross sectional area of the carbon black may be between any of the minimum and maximum values noted above, including for example, but not limited to at least 1μ² and no greater than 450μ² or at least 5μ² and no greater than 100μ².

In an embodiment, the blend may include carbon black of a particular size that may provide improved performance and/or manufacturing of the asphalt mix. In an embodiment, the carbon black comprises a cross sectional area standard deviation of no greater than 3000μ² or no greater than 1000μ² or no greater than 500μ² or no greater than 250μ² or no greater than 100μ² or no greater than 50μ² or no greater than 30. In an alternative embodiment, the carbon black comprises a cross sectional area standard deviation of at least 1μ² or at least 5μ² or at least 10μ². It will be appreciated that the cross sectional area standard deviation of the carbon black may be between any of the minimum and maximum values noted above, including for example, but not limited to at least 1μ² and no greater than 250μ² or at least 5μ² and no greater than 100μ².

In an embodiment, the blend may include carbon black of a particular size that may provide improved performance and/or manufacturing of the asphalt mix. In an embodiment, the carbon black comprises an average diameter of no greater than 30μ or no greater than 28μ or no greater than 26μ or no greater than 24μ or no greater than 22μ or no greater than 20μ or no greater than 18μ or no greater than 16μ or no greater than 14μ or no greater than 12μ or no greater than 10μ or no greater than 8μ. In an alternative embodiment, the carbon black comprises an average diameter of at least 1μ or at least 3μ or at least 5μ. It will be appreciated that the average diameter of the carbon black may be between any of the minimum and maximum values noted above, including for example, but not limited to at least 1μ and no greater than 24μ or at least 5μ and no greater than 12μ.

In an embodiment, the blend may include carbon black of a particular size that may provide improved performance and/or manufacturing of the asphalt mix. In an embodiment, the carbon black comprises a diameter standard deviation of no greater than 25μ or no greater than 20μ or no greater than 15μ or no greater than 10μ. In an alternative embodiment, the carbon black comprises a diameter standard deviation of at least 1μ or at least 2μ or at least 3μ. It will be appreciated that the diameter standard deviation of the carbon black may be between any of the minimum and maximum values noted above, including for example, but not limited to at least 1μ and no greater than 25μ or at least 3μ and no greater than 10μ.

In an embodiment, the blend may have a particular carbon black content that may provide improved performance and/or manufacturing of the asphalt mix. In an embodiment the blend can have a carbon black content of at least 2.0 wt. % carbon black for a total weight of the blend or at least 2.1 wt. % carbon black or at least 2.2 wt. % carbon black or at least 2.3 wt. % carbon black or at least 2.4 wt. % carbon black or at least 2.5 wt. % carbon black or at least 2.6 wt. % carbon black or at least 2.7 wt. % carbon black or at least 2.8 wt. % carbon black or at least 2.9 wt. % carbon black or at least 3.0 wt. % carbon black or at least 3.1 wt. % carbon black or at least 3.2 wt. % carbon black or at least 3.3 wt. % carbon black or at least 3.4 wt. % carbon black or at least 3.5 wt. % carbon black or at least 3.6 wt. % carbon black or at least 3.7 wt. % carbon black or at least 3.8 wt. % carbon black or at least 3.9 wt. % carbon black or at least 4.0 wt. % carbon black or at least 4.1 wt. % carbon black or at least 4.2 wt. % carbon black or at least 4.3 wt. % carbon black or at least 4.4 wt. % carbon black or at least 4.5 or at least 4.6 wt. % carbon black or at least 4.7 wt. % carbon black or at least 4.8 wt. % carbon black or at least 4.9 wt. % carbon black or at least 5.0 wt. % carbon black or at least 5.1 wt. % carbon black or at least 5.2 wt. % carbon black or at least 5.3 wt. % carbon black or at least 5.4 wt. % carbon black or at least 5.5 wt. % carbon black. In an embodiment, the blend can have a carbon black content of not greater than 25 wt. % carbon black for a total weight of the blend or not greater than 24 wt. % carbon black or not greater than 23 wt. % carbon black or not greater than 22 wt. % carbon black or not greater than 21 wt. % carbon black or not greater than 20 wt. % carbon black or not greater than 19 wt. % carbon black or not greater than 18 wt. % carbon black or not greater than 17 wt. % carbon black or not greater than 16 wt. % carbon black or not greater than 15 wt. % carbon black or not greater than 14 wt. % carbon black or not greater than 13 wt. % carbon black or not greater than 12 wt. % carbon black or not greater than 11 wt. % carbon black or not greater than 10 wt. % carbon black or not greater than 9 wt. % carbon black or not greater than 8 wt. % carbon black. It will be appreciated that the carbon black content may be between any of the minimum and maximum values noted above, including for example, but not limited to at least 2.5 wt. % and not greater than 10 wt. % or at least 4.5 wt. % and not greater than 8 wt. %.

In an embodiment, the first polymer additive may have a particular composition that may facilitate improved performance and/or manufacturing of the asphalt mix. In an embodiment, the first polymer additive is a styrene-butadiene-styrene (sbs) polymer. The sbs polymer can be a linear sbs polymer, a radial sbs polymer, or a combination thereof.

In an embodiment, the sbs polymer can have a particular polybutadiene mid-block vinyl content that may facilitate improved performance and/or manufacturing of the asphalt mix. In an embodiment, the sbs polymer can have a vinyl content of at least 5% or at least 6% or at least 7% or at least 8% or at least 9% or at least 10% or at least 11% or at least 12% or at least 13% or at least 14% or at least 15% or at least 16% or at least 17% or at least 18% or at least 19% or at least 20% or at least 21% or at least 22% or at least 23% or at least 24% or at least 25% or at least 26% or at least 27% or at least 28% or at least 29% or at least 30% or at least 31% or at least 32% or at least 33% or at least 34% or at least 35% or at least 36% or at least 37% or at least 38% or at least 39% or at least 40%. In an embodiment, the sbs polymer can have a vinyl content of not greater than 75% or not greater than 60% or not greater than 50% or not greater than 45%. It will be appreciated that the vinyl content of the sbs polymer may be between any of the minimum and maximum values noted above, including for example, but not limited to, at least 25% and not greater than 60% or at least 10% and not greater than 45%.

In an embodiment, the sbs polymer can have a particular styrene content that may facilitate improved performance and/or manufacturing of the asphalt mix. In an embodiment, the sbs polymer can have a styrene content of at least 10% or at least 12% or at least 14% or at least 16% or at least 18% or at least 20% or at least 22% or at least 24% or at least 26% or at least 28% or at least 30% or at least 32% or at least 34% or at least 36% or at least 38% or at least 40%. In an embodiment, the sbs polymer can have a styrene content of not greater than 50% or not greater than 48% or not greater than 46% or not greater than 44% or not greater than 42% or not greater than 40% or not greater than 38% or not greater than 36% or not greater than 34% or not greater than 32% or not greater than 30%. It will be appreciated that the styrene content of the sbs polymer may be between any of the minimum and maximum values noted above, including for example, but not limited to, at least 24% and not greater than 50% or at least 10% and not greater than 44%.

In an embodiment, the sbs polymer can have a particular molecular weight that may facilitate improved performance and/or manufacturing of the asphalt mix. In an embodiment, the sbs polymer can have a molecular weight of at least 180,000 or at least 190,000 or at least 200,000 or at least 210,000 or at least 220,000 or at least 230,000 or at least 240,000 or at least 250,000. In an embodiment, the sbs polymer can have a molecular weight of no greater than 320,000 or no greater than 310,000 or no greater than 300,000 or no greater than 290,000. It will be appreciated that the molecular weight of the sbs polymer may be between any of the minimum and maximum values noted above, including at least 180,000 and no greater than 320,000 or at least 250,000 and not greater than 300,000.

In an embodiment, the asphalt blend can further include a second polymer additive. The second polymer additive may have a particular composition that may facilitate improved performance and/or manufacturing of the asphalt mix. In an embodiment, the second polymer additive can be a di-block styrene butadiene polymer. In an embodiment, the second polymer additive can be a linear sbs polymer, a radial sbs polymer, or a combination thereof.

In an embodiment, the second polymer additive can have a vinyl content that may facilitate improved performance and/or manufacturing of the asphalt mix. In an embodiment, the second polymer additive can have a vinyl content of at least 5% or at least 6% or at least 7% or at least 8% or at least 9% or at least 10% or at least 11% or at least 12% or at least 13% or at least 14% or at least 15% or at least 16% or at least 17% or at least 18% or at least 19% or at least 20% or at least 21% or at least 22% or at least 23% or at least 24% or at least 25% or at least 26% or at least 27% or at least 28% or at least 29% or at least 30% or at least 31% or at least 32% or at least 33% or at least 34% or at least 35% or at least 36% or at least 37% or at least 38% or at least 39% or at least 40%. In an embodiment, the second polymer additive can have a vinyl content of not greater than 75% or not greater than 60% or not greater than 50% or not greater than 45% or not greater than 40% or not greater than 38% or not greater than 36% or not greater than 34% or not greater than 32% or not greater than 30% or not greater than 28% or not greater than 26% or not greater than 24% or not greater than 20% or not greater than 18% or not greater than 26% or not greater than 24% or not greater than 12% or not greater than 10%. It will be appreciated that the vinyl content of the second polymer additive may be between any of the minimum and maximum values noted above, including for example, but not limited to, at least 25% and not greater than 60% or at least 10% and not greater than 45%.

In an embodiment, the second polymer additive can have a particular styrene content that may facilitate improved performance and/or manufacturing of the asphalt mix. In an embodiment, the second polymer additive can have a styrene content of at least 1% or at least 2% or at least 3% or at least 4% or at least 5% or at least 6% or at least 7% or at least 8% or at least 9% or at least 10% or at least 11% or at least 12% or at least 13% or at least 14% or at least 15% or at least 16% or at least 17% or at least 18% or at least 19% or at least 20% or at least 21% or at least 22% or at least 23% or at least 24% or at least 25% or at least 26% or at least 27% or at least 28% or at least 29% or at least 30% or at least 31% or at least 32% or at least 33% or at least 34% or at least 35% or at least 36% or at least 37% or at least 38% or at least 39% or at least 40%. In an embodiment, the second polymer additive can have a styrene content of not greater than 50% or not greater than 48% or not greater than 46% or not greater than 44% or not greater than 42% or not greater than 40% or not greater than 38% or not greater than 36% or not greater than 34% or not greater than 32% or not greater than 30%. It will be appreciated that the styrene content of the second polymer additive may be between any of the minimum and maximum values noted above, including for example, but not limited to, at least 24% and not greater than 50% or at least 10% and not greater than 44%.

In an embodiment, the second polymer additive can have a particular molecular weight that may facilitate improved performance and/or manufacturing of the asphalt mix. In an embodiment, the second polymer additive can have a molecular weight of at least 60,000 or at least 70,000 or at least 80,000 or at least 90,000 or at least 100,000 or at least 110,000 or at least 120,000 or at least 130,000 or at least 140,000 or at least 150,000 or at least 160,000 or at least 170,000 or at least 180,000 or at least 190,000 or at least 200,000 or at least 210,000 or at least 220,000 or at least 230,000 or at least 240,000 or at least 250,000. In an embodiment, the sbs polymer can have a molecular weight of no greater than 350,000 or no greater than 340,000 or no greater than 330,000 or no greater than 320,000 or no greater than 310,000 or no greater than 300,000 or no greater than 290,000. It will be appreciated that the molecular weight of the second polymer additive may be between any of the minimum and maximum values noted above, including at least 180,000 and no greater than 320,000 or at least 250,000 and not greater than 300,000.

In an embodiment, the asphalt blend may have a particular total polymer additive content that may provide improved performance and/or manufacturing of the asphalt mix. In an embodiment, the blend can have a total polymer additive content of at least 1 wt. % polymer additive content for a total weight of the blend or at least 1.5 wt. % polymer additive or at least 2 wt. % polymer additive or at least 2.5 wt. % polymer additive or at least 3 wt. % polymer additive or at least 3.5 wt. % polymer additive or at least 4 wt. % polymer additive or at least 4.5 wt. % polymer additive or at least 5 wt. % polymer additive or at least 5.5 wt. % polymer additive or at least 6 wt. % polymer additive for a total weight of the blend. In an embodiment, the blend can have a total polymer additive content of not greater than 10 wt. % polymer additive for a total weight of the blend or not greater than 9 wt. % polymer additive or not greater than 8 wt. % polymer additive or not greater than 7 wt. % polymer additive or not greater than 6 wt. % polymer additive or not greater than 5 wt. % polymer additive for a total weight of the blend. It will be appreciated that the total polymer additive content may be between any of the minimum and maximum values noted above, including for example, but not limited to at least 2.5 wt. % and not greater than 10 wt. % or at least 4.5 wt. % and not greater than 8 wt. %.

In an embodiment, the asphalt blend may have a particular first polymer additive content that may provide improved performance and/or manufacturing of the asphalt mix. In an embodiment, the blend can have a first polymer additive content of at least 1 wt. % first polymer additive content for a total weight of the blend or at least 1.5 wt. % first polymer additive or at least 2 wt. % first polymer additive or at least 2.5 wt. % first polymer additive or at least 3 wt. % first polymer additive or at least 3.5 wt. % first polymer additive or at least 4 wt. % first polymer additive or at least 4.5 wt. % first polymer additive or at least 5 wt. % first polymer additive or at least 5.5 wt. % first polymer additive or at least 6 wt. % first polymer additive for a total weight of the blend. In an embodiment, the blend can have a first polymer additive content of not greater than 10 wt. % first polymer additive for a total weight of the blend or not greater than 9 wt. % first polymer additive or not greater than 8 wt. % first polymer additive or not greater than 7 wt. % first polymer additive or not greater than 6 wt. % first polymer additive or not greater than 5 wt. % first polymer additive for a total weight of the blend. It will be appreciated that the first polymer additive content may be between any of the minimum and maximum values noted above, including for example, but not limited to at least 2.5 wt. % and not greater than 10 wt. % or at least 4.5 wt. % and not greater than 8 wt. %.

In an embodiment, the asphalt blend may have a particular second polymer additive content that may provide improved performance and/or manufacturing of the asphalt mix. In an embodiment, the blend can have a second polymer additive content of at least 1 wt. % second polymer additive content for a total weight of the blend or at least 1.5 wt. % second polymer additive or at least 2 wt. % second polymer additive or at least 2.5 wt. % second polymer additive or at least 3 wt. % second polymer additive or at least 3.5 wt. % second polymer additive or at least 4 wt. % second polymer additive or at least 4.5 wt. % second polymer additive or at least 5 wt. % second polymer additive or at least 5.5 wt. % second polymer additive or at least 6 wt. % second polymer additive for a total weight of the blend. In an embodiment, the blend can have a second polymer additive content of not greater than 10 wt. % second polymer additive for a total weight of the blend or not greater than 9 wt. % second polymer additive or not greater than 8 wt. % second polymer additive or not greater than 7 wt. % second polymer additive or not greater than 6 wt. % second polymer additive or not greater than 5 wt. % second polymer additive for a total weight of the blend. It will be appreciated that the second polymer additive content may be between any of the minimum and maximum values noted above, including for example, but not limited to at least 2.5 wt. % and not greater than 10 wt. % or at least 4.5 wt. % and not greater than 8 wt. %.

In an embodiment, the asphalt blend may also include a wax. The wax may have a particular composition that may facilitate improved performance and/or manufacturing of the filled asphalt mix. In an embodiment, the wax can include a paraffin wax, an alpha olefin wax, a polyamide wax, an ethylene vinyl acetate (EVA) wax, a polypropylene wax, a polyethylene wax or a combination thereof. In an embodiment, the wax may include a polypropylene wax. In an embodiment, the wax may include a polyethylene wax. In an embodiment, the wax may include a polypropylene and polyethylene wax. In an embodiment, the wax can be a recycled wax. The wax may be processed from a feed including recycled or virgin plastics.

In an embodiment, the asphalt blend may have a particular wax content that may provide improved performance and/or manufacturing of the asphalt mix. In an embodiment, the blend can have a wax content of at least 0.5 wt. % wax for a total weight of the blend or at least 1 wt. % or at least 1.5 wt. % or at least 2 wt. %. In an embodiment, the blend can have a wax content of not greater than 10 wt. % or not greater than 5 wt. % or not greater than 4 wt. % or not greater than 3 wt. % or not greater than 2 wt. %. It will be appreciated that the wax content may be between any of the minimum and maximum values noted above, including for example, but not limited to at least 0.5 wt. % and not greater than 5 wt. % or at least 1 wt. % and not greater than 4 wt. %.

In an embodiment, the asphalt blend may have a particular softening point that may provide improved performance and/or manufacturing of the asphalt blend or mix. In an embodiment, the softening point may be at least 200° F. or at least 201° F. or at least 202° F. or at least 203° F. or at least 204° F. or at least 205° F. or at least 206° F. or at least 207° F. or at least 208° F. or at least 209° F. or at least 210° F. or at least 211° F. or at least 212° F. or at least 213° F. or at least 214° F. or at least 215° F. or at least 216° F. or at least 217° F. or at least 218° F. or at least 219° F. In an embodiment, the softening point may be not greater than 300° F. or not greater than 290° F. or not greater than 280° F. or not greater than 270° F. or not greater than 260° F. or not greater than 250° F. or not greater than 240° F. or not greater than 230° F. or not greater than 220° F. It will be appreciated that the softening point may be between any of the minimum and maximum values noted above, including for example, but not limited to, at least 200° F. and not greater than 290° F. or at least 206° F. and not greater than 260° F.

In an embodiment, the asphalt blend may have a particular penetration at 32° F. that may provide improved performance and/or manufacturing of the asphalt blend or mix. In an embodiment, the penetration at 32° F. may be no greater than 20 dmm or no greater than 19 dmm or no greater than 18 dmm or no greater than 17 dmm or no greater than 16 dmm or no greater than 15 dmm or no greater than 14 dmm or no greater than 13 dmm or no greater than 12 dmm or no greater than 11 dmm. In an embodiment, the penetration at 32° F. may be at least 1 dmm or at least 2 dmm or at least 3 dmm or at least 4 dmm or at least 5 dmm or at least 6 dmm or at least 7 dmm or at least 8 dmm or at least 9 dmm or at least 10 dmm or at least 11 dmm. It will be appreciated that the penetration at 32° F. may be between any of the minimum and maximum values noted above, including for example, but not limited to, at least 1 dmm and no greater than 13 dmm or at least 2 dmm and no greater than 14 dmm.

In an embodiment, the asphalt blend may have a particular penetration at 77° F. that may provide improved performance and/or manufacturing of the asphalt blend or mix. In an embodiment, the penetration at 77° F. may be no greater than 40 dmm or no greater than 39 dmm or no greater than 38 dmm or no greater than 37 dmm or no greater than 36 dmm or no greater than 35 dmm or no greater than 34 dmm or no greater than 33 dmm or no greater than 32 dmm. In an embodiment, the penetration at 77° F. may be at least 21 dmm or at least 22 dmm or at least 23 dmm or at least 24 dmm or at least 25 dmm or at least 26 dmm or at least 27 dmm or at least 28 dmm or at least 29 dmm or at least 30 dmm or at least 31 dmm or at least 32 dmm. It will be appreciated that the penetration at 77° F. may be between any of the minimum and maximum values noted above, including for example, but not limited to, at least 21 dmm and no greater than 32 dmm or at least 29 dmm and no greater than 33 dmm.

In an embodiment, the asphalt blend may have a particular penetration at 115° F. that may provide improved performance and/or manufacturing of the asphalt blend or mix. In an embodiment, the penetration at 115° F. may be no greater than 88 dmm or no greater than 87 dmm or no greater than 86 dmm or no greater than 85 dmm or no greater than 84 dmm or no greater than 83 dmm or no greater than 82 dmm or no greater than 81 dmm or no greater than 80 dmm or no greater than 79 dmm or no greater than 78 dmm or no greater than 77 dmm or no greater than 76 dmm. In an embodiment, the penetration at 115° F. may be at least 61 dmm or at least 62 dmm or at least 63 dmm or at least 64 dmm or at least 65 dmm or at least 66 dmm or at least 67 dmm or at least 68 dmm or at least 69 dmm or at least 70 dmm or at least 71 dmm or at least 72 dmm or at least 73 dmm or at least 74 dmm or at least 75 dmm or at least 76 dmm. It will be appreciated that the penetration at 115° F. may be between any of the minimum and maximum values noted above, including for example, but not limited to, at least 61 dmm and no greater than 80 dmm or at least 70 dmm and no greater than 77 dmm.

In an embodiment, the asphalt blend may have a particular viscosity at 400° F. that may provide improved performance and/or manufacturing of the asphalt blend or mix. In an embodiment, the viscosity may be at least 300 cps or at least 310 cps or at least 320 cps or at least 330 cps or at least 340 cps or at least 350 cps or at least 360 cps. In an embodiment, the viscosity may be no greater than 1000 cps or no greater than 900 cps or no greater than 800 cps or no greater than 700 cps or no greater than 600 cps or no greater than 500 cps or no greater than 400 cps. It will be appreciated that the viscosity at 400° F. may be between any of the minimum and maximum values noted above, including for example, but not limited to, at least 300 cps and not greater than 1000 cps or at least 320 cps and not greater than 400 cps.

The process can continue with step 103, mixing the asphalt blend with a filler to provide a filled asphalt mix.

In an embodiment, mixing the filled asphalt mix may be done at a particular temperature that may facilitate improved performance and/or manufacturing of the asphalt mix. In an embodiment, the mixing may be done at a temperature of at least 350° F. or at least 360° F. or at least 370° F. or at least 380° F. or at least 390° F. In an embodiment, mixing may be done at a temperature of no greater than 450° F. or no greater than 440° F. or no greater than 430° F. or no greater than 420° F. or no greater than 410° F. It will be appreciated that the mixing temperature may be between any of the minimum and maximum values noted above, including for example, but not limited to, at least 350° F. and not greater than 440° F. or at least 370° F. and not greater than 430° F.

In an embodiment, the filler may have a particular composition that may facilitate improved performance and/or manufacturing of the filled asphalt mix. In an embodiment, the filler can be limestone. In an embodiment, the filler can be CaCO₃.

In an embodiment, the filled asphalt mix may have a particular filler content that may provide improved performance and/or manufacturing of the asphalt mix. In an embodiment, the mix can have a filler content of at least 40 wt. % filler for a total weight of the mix or at least 42 wt. % or at least 44 wt. % or at least 46 wt. % or at least 48 wt. % or at least 50 wt. % or at least 52 wt. % or at least 54 wt. % or at least 56 wt. % or at least 58 wt. % or at least 60 wt. % or at least 62 wt. % or at least 64 wt. % or at least 66 wt. % or at least 68 wt. % or at least 70 wt. % or at least 72 wt. % or at least 74 wt. % or at least 76 wt. % or at least 78 wt. % or at least 80 wt. %. In an embodiment, the mix can have a filler content of not greater than 90 wt. % filler for a total weight of the mix or not greater than 88 wt. % or not greater than 86 wt. % or not greater than 84 wt. % or not greater than 82 wt. % or not greater than 80 wt. % or not greater than 78 wt. % or not greater than 76 wt. % or not greater than 74 wt. % or not greater than 72 wt. % or not greater than 70 wt. %. It will be appreciated that the filler content may be between any of the minimum and maximum values noted above, including for example, but not limited to at least 40 wt. % and not greater than 90 wt. % or at least 60 wt. % and not greater than 80 wt. %.

In an embodiment, the filled asphalt mix may have a particular softening point that may provide improved performance and/or manufacturing of the asphalt mix. In an embodiment, the softening point may be not greater than 325° F. or not greater than 320° F. or not greater than 315 OF or not greater than 310° F. or not greater than 305° F. or not greater than 300° F. or not greater than 295° F. or not greater than 290° F. In an embodiment, the softening point may be at least 250° F. or at least 251° F. or at least 252° F. or at least 253° F. or at least 254° F. or at least 255° F. or at least 256° F. or at least 257° F. or at least 258° F. or at least 259° F. or at least 260° F. or at least 261° F. or at least 262° F. or at least 263° F. or at least 264° F. or at least 265° F. or at least 266° F. or at least 267° F. or at least 268° F. or at least 269° F. or at least 270° F. or at least 271° F. or at least 272° F. or at least 273° F. or at least 274° F. or at least 275° F. or at least 276° F. or at least 277° F. or at least 278° F. or at least 279° F. or at least 280° F. It will be appreciated that the softening point may be between any of the minimum and maximum values noted above, including for example, but not limited to, at least 250° F. and not greater than 325° F. or at least 264° F. and not greater than 310° F.

In an embodiment, the filled asphalt mix may have a particular penetration at 32° F. that may provide improved performance and/or manufacturing of the asphalt mix. In an embodiment, the penetration at 32° F. may be no greater than 10 dmm or no greater than 9 dmm or no greater than 8 dmm or no greater than 7 dmm or no greater than 6 dmm. In an embodiment, the penetration at 32° F. may be at least 1 dmm or at least 2 dmm or at least 3 dmm or at least 4 dmm or at least 5 dmm or at least 6 dmm or at least 7 dmm or at least 8 dmm or at least 9 dmm or at least 10 dmm or at least 11 dmm. It will be appreciated that the penetration at 32° F. may be between any of the minimum and maximum values noted above, including for example, but not limited to, at least 1 dmm and no greater than 10 dmm or at least 2 dmm and no greater than 8 dmm.

In an embodiment, the filled asphalt mix may have a particular penetration at 77° F. that may provide improved performance and/or manufacturing of the asphalt mix. In an embodiment, the penetration at 77° F. may be no greater than 20 dmm or no greater than 19 dmm or no greater than 18 dmm or no greater than 17 dmm or no greater than 16 dmm or no greater than 15 dmm or no greater than 14 dmm or no greater than 13 dmm or no greater than 12 dmm. In an embodiment, the penetration at 77° F. may be at least 1 dmm or at least 2 dmm or at least 3 dmm or at least 4 dmm or at least 5 dmm or at least 6 dmm or at least 7 dmm or at least 8 dmm or at least 9 dmm or at least 10 dmm or at least 11 dmm or at least 12 dmm. It will be appreciated that the penetration at 77° F. may be between any of the minimum and maximum values noted above, including for example, but not limited to, at least 1 dmm and no greater than 20 dmm or at least 9 dmm and no greater than 13 dmm.

In an embodiment, the filled asphalt mix may have a particular penetration at 115° F. that may provide improved performance and/or manufacturing of the asphalt mix. In an embodiment, the penetration at 115° F. may be no greater than 40 dmm or no greater than 39 dmm or no greater than 38 dmm or no greater than 37 dmm or no greater than 36 dmm or no greater than 35 dmm or no greater than 34 dmm or no greater than 33 dmm or no greater than 32 dmm. In an embodiment, the penetration at 115° F. may be at least 21 dmm or at least 22 dmm or at least 23 dmm or at least 24 dmm or at least 25 dmm or at least 26 dmm or at least 27 dmm or at least 28 dmm or at least 29 dmm or at least 30 dmm or at least 31 dmm or at least 32 dmm. It will be appreciated that the penetration at 115° F. may be between any of the minimum and maximum values noted above, including for example, but not limited to, at least 21 dmm and no greater than 40 dmm or at least 30 dmm and no greater than 33 dmm.

In an embodiment, the filled asphalt mix may have a particular viscosity at 400° F. that may provide improved performance and/or manufacturing of the asphalt mix. In an embodiment, the viscosity may be at least 3600 cps or at least 3700 cps or at least 3800 cps or at least 3900 cps or at least 4000 cps or at least 4100 cps or at least 4200 cps or at least 4300 cps or at least 4400 cps or at least 4500 cps or at least 4600 cps or at least 4700 cps or at least 4800 cps or at least 4900 cps or at least 5000 cps or at least 5100 cps or at least 5200 cps or at least 5300 cps. In an embodiment, the viscosity may be no greater than 10000 cps or no greater than 9000 cps or no greater than 8000 cps or no greater than 7000 cps or no greater than 6000 cps or no greater than 5000 cps. It will be appreciated that the viscosity at 400° F. may be between any of the minimum and maximum values noted above, including for example, but not limited to, at least 3800 cps and not greater than 8000 cps or at least 4300 cps and not greater than 6000 cps.

In an embodiment, the filled asphalt mix may have a non-adhesion factor that may provide improved performance and/or manufacturing of the asphalt mix. Non-adhesion factor (NAF) may be measured according to the process outlined in the examples. In an embodiment, the NAF may be not greater than 1.0 PLI or not greater than 0.95 PLI or not greater than 0.90 PLI or not greater than 0.85 PLI or not greater than 0.80 PLI or not greater than 0.75 PLI or not greater than 0.70 PLI or not greater than 0.65 PLI or not greater than 0.60 PLI or not greater than 0.55 PLI or not greater than 0.50 PLI or not greater than 0.45 PLI or not greater than 0.40 PLI or not greater than 0.35 PLI or not greater than 0.35 PLI. In an embodiment, the NAF may be at least 0.05 PLI or at least 0.10 PLI or at least 0.15 PLI or at least 0.20 PLI. It will be appreciated that the NAF may be between any of the minimum and maximum values noted above, including for example, but not limited to, at least 0.10 PLI and not greater than 1.0 PLI or at least 0.05 PLI and not greater than 0.50 PLI.

In an embodiment, the filled asphalt mix may have a particular weatherability that may provide improved performance and/or manufacturing of the asphalt mix. In an embodiment, the weatherability may be at least 30 days or at least 40 days or at least 50 days or at least 60 days or at least 70 days or at least 80 days or at least 90 days or at least 100 days or at least 110 days or at least 120 days or at least 130 days or at least 140 days or at least 150 days or at least 160 days or at least 70 days or at least 180 days or at least 190 days or at least 200 days. In an embodiment, the weatherability may be no greater than 1000 days. It will be appreciated that the weatherability may be between any of the minimum and maximum values noted above, including for example, but not limited to, at least 20 days and not greater than 1000 days or at least 200 days and not greater than 1000 days.

In an embodiment, a shingle can include a substrate coated with any of the asphalt blends or mixes described herein.

In an embodiment, the shingles may be packaged in bundles. In an embodiment, the bundles may include at least 10 shingles or at least 11 shingles or at least 12 shingles or at least 13 shingles or at least 14 shingles or at least 15 shingles or at least 16 shingles or at least 17 shingles or at least 18 shingles or at least 19 shingles or at least 20 shingles. In an embodiment, the bundles may include no greater than 30 shingles or no greater than 28 shingles or no greater than 26 shingles or no greater than 24 shingles or no greater than 22 shingles.

In an embodiment, a pallet can include a palleted plurality of roofing shingles comprising a plurality of roofing shingles disposed in one or more stacks on a pallet, wherein the pallet has a top surface formed of a plurality of top boards, and wherein
(a) adjacent boards of the plurality of top boards have a gap of no more than one inch therebetween at the top surfaces thereof; and/or
(b) the plurality of top boards takes up at least 85% of the occluded area of the top surface of the pallet;
(c) each of the plurality of top boards has a thickness of at least 0.55 inches.

The palleted shingles can include shingles including asphalt blends or mixes according to the embodiments herein. In an embodiment, a pallet can include 3-5 stacks. In an embodiment, a pallet can include 4 stacks.

The shingles can be packaged in one or more bundles making up each stack, the bundles as described above. As the person of ordinary skill in the art will appreciate, each bundle can include any desired number of shingles, e.g., in the range of 16-30, for example, 20 shingles per bundle or 22 shingles per bundle. Shingles can be packaged face-to-face in pairs. Alternatively, shingles can be packed face-to-back. Bundles can be stacked on a pallet in any desirable manner. For example, a pallet can include 3-5 stacks of bundles, or 4 stacks of bundles.

A pallet can have bundles of shingles stacked, at least 6 bundles high or at least 7 bundles high or at least 8 bundles high or at least 9 bundles high or at least 10 bundles high or at least 11 bundles high or at least 12 bundles high. The stacks may also include no greater than 16 bundles or no greater than 15 bundles or no greater than 14 bundles or no greater than 13 bundles or no greater than 12 bundles.

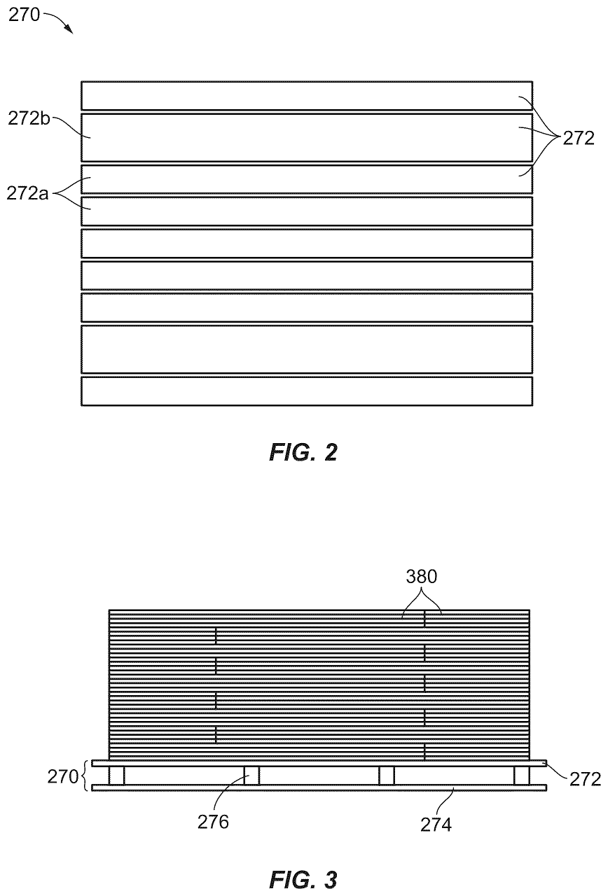

An example of a pallet is shown in schematic top view in FIG. 2, and in schematic side view (with shingles stacked thereon) in FIG. 3. Pallet 270 includes a plurality of top boards 272 and a plurality of bottom boards 274, affixed (e.g., via nails or screws) to opposite sides of a series of stringers 276. Notably, the top boards need not be uniform; for example, in the embodiment of FIGS. 2 and 3, there are two types of top boards with different widths, 272a (narrower) and 272b (wider). In FIG. 3, bundles 380 are stacked on the pallet. Each bundle has, e.g., 20 or 22 roofing shingles. And there are nine courses of bundles stacked on the pallet; each course has three bundles extending parallel to the plane of the page and one bundle extending perpendicular to the plane of the page, as is conventional. This is a single “stack” configuration.

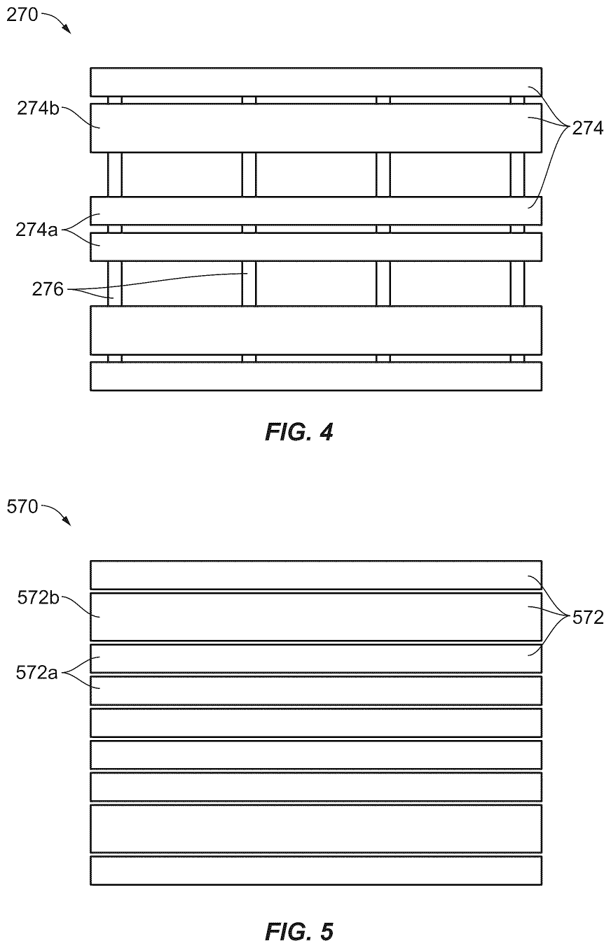

FIGS. 4 and 5 exhibit two examples of arrangements of the plurality of bottom boards of pallets of the disclosure. FIG. 4 is a schematic bottom view of the pallet of FIG. 2. Pallet 270 includes a plurality of bottom boards 274 affixed (e.g., via nails or screws) to bottom sides of stringers 276. Like the top boards, the bottom boards need not be uniform; for example, in the embodiment of FIG. 4, there are two types of bottom boards with different widths, 274 a (narrower) and 274 b (wider). Notably, in this embodiment, as is common for pallets, the bottom boards do not substantially fill the area at the bottom of the pallet.

FIG. 5 is a schematic bottom view of another pallet 570 useful in various embodiments of the disclosure. In this embodiment, the structure of the top boards and the stringers is as described above with respect to FIGS. 2 and 3. Here, the bottom boards substantially fill the area at the bottom of the pallet. As shown, the pallet includes boards 572 with different widths, 572a (narrower) and 572b (wider).

### EMBODIMENTS

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. An asphalt blend comprising:
asphalt,
   a first polymer additive,
   carbon black,
      the blend having softening point of at least 200° F., or a penetration at 115° F. of less than or equal to 86 dmm.

Embodiment 2. The blend of embodiment 1, wherein the asphalt comprises paving grade asphalt.

Embodiment 3. The blend of embodiment 2, wherein the paving grade asphalt comprises a high temperature performance grade of at least 46° C. or at least 52° C. or at least 58° C. or at least 64° C. or at least 70° C. or at least 82° C.

Embodiment 4. The blend of embodiment 2, wherein the paving grade asphalt comprises a high temperature performance grade of not greater than 82° C. or not greater than 76° C. or not greater than 70° C. or not greater than 64° C. or not greater than 58° C. or not greater than 52° C. or not greater than 46° C.

Embodiment 5. The blend of embodiment 2, wherein the paving grade asphalt comprises a low temperature performance grade of at least −46° C. or at least −40° C. or at least −34° C. or at least −28° C. or at least −22° C. or at least −16° C. or at least −10° C.

Embodiment 6. The blend of embodiment 2, wherein the paving grade asphalt comprises a low temperature performance grade of not greater than −10° C. or not greater than −16° C. or not greater than −22° C. or not greater than −28° C. or not greater than −34° C. or not greater than −40° or not greater than −46° C.

Embodiment 7. The blend of embodiment 2, wherein the paving grade asphalt comprises PG 64-22 asphalt.

Embodiment 8. The blend of embodiment 1, wherein the asphalt blend comprises an asphalt content of at least 70 wt. % for a total weight of the blend or at least 72 wt. % or at least 74 wt. % or at least 76 wt. % or at least 78 wt. % or at least 80 wt. % or at least 82 wt. % or at least 84 wt. % or at least 86 wt. % or at least 88 wt. % or at least 90 wt. % or at least 92 wt. % or at least 94 wt. %.

Embodiment 9. The blend of embodiment 1, wherein the asphalt blend comprises an asphalt content of no greater than 99 wt. % for a total weight of the blend or no greater than 98 wt. % or no greater than 96 wt. % or no greater than 94 wt. % or no greater than 92 wt. % or no greater than 90 wt. % or no greater than 88 wt. % or no greater than 86 wt. % or no greater than 84 wt. % or no greater than 82 wt. % or no greater than 80 wt. %.

Embodiment 10. The blend of embodiment 1, wherein the carbon black comprises virgin carbon black, reembodimented carbon black, recycled carbon black, or a combination thereof.

Embodiment 11. The blend of embodiment 1, wherein the carbon black comprises an average cross sectional area of no greater than 600μ² or no greater than 550μ² or no greater than 500μ² or no greater than 450μ² or no greater than 400μ² or no greater than 350μ² or no greater than 300μ² or no greater than 250μ² or no greater than 200μ² or no greater than 150μ² or no greater than 100μ² or no greater than 50μ².

Embodiment 12. The blend of embodiment 1, wherein the carbon black comprises an average cross sectional area of at least 1μ² or at least 5μ² or at least 10μ².

Embodiment 13. The blend of embodiment 1, wherein the carbon black comprises a cross sectional area standard deviation of no greater than 3000μ² or no greater than 1000μ² or no greater than 500μ² or no greater than 250μ² or no greater than 100μ² or no greater than 50μ² or no greater than 30.

Embodiment 14. The blend of embodiment 1, wherein the carbon black comprises a cross sectional area standard deviation of at least 1μ² or at least 5μ² or at least 10μ².

Embodiment 15. The blend of embodiment 1, wherein the carbon black comprises an average diameter of no greater than 30μ or no greater than 28μ or no greater than 26μ or no greater than 24μ or no greater than 22μ or no greater than 20μ or no greater than 18μ or no greater than 16μ or no greater than 14μ or no greater than 12μ or no greater than 10μ or no greater than 8μ.

Embodiment 16. The blend of embodiment 1, wherein the carbon black comprises an average diameter of at least 1μ or at least 3μ or at least 5μ.

Embodiment 17. The blend of embodiment 1, wherein the carbon black comprises a diameter standard deviation of no greater than 25μ or no greater than 20μ or no greater than 15μ or no greater than 10μ.

Embodiment 18. The blend of embodiment 1, wherein the carbon black comprises a diameter standard deviation of at least 1μ or at least 2μ or at least 3μ.

Embodiment 19. The blend of embodiment 1, wherein the asphalt blend comprises at least 2.0 wt. % carbon black for a total weight of the blend or at least 2.1 wt. % carbon black or at least 2.2 wt. % carbon black or at least 2.3 wt. % carbon black or at least 2.4 wt. % carbon black or at least 2.5 wt. % carbon black or at least 2.6 wt. % carbon black or at least 2.7 wt. % carbon black or at least 2.8 wt. % carbon black or at least 2.9 wt. % carbon black or at least 3.0 wt. % carbon black or at least 3.1 wt. % carbon black or at least 3.2 wt. % carbon black or at least 3.3 wt. % carbon black or at least 3.4 wt. % carbon black or at least 3.5 wt. % carbon black or at least 3.6 wt. % carbon black or at least 3.7 wt. % carbon black or at least 3.8 wt. % carbon black or at least 3.9 wt. % carbon black or at least 4.0 wt. % carbon black or at least 4.1 wt. % carbon black or at least 4.2 wt. % carbon black or at least 4.3 wt. % carbon black or at least 4.4 wt. % carbon black or at least 4.5 wt. % carbon black or at least 4.6 wt. % carbon black or at least 4.7 wt. % carbon black or at least 4.8 wt. % carbon black or at least 4.9 wt. % carbon black or at least 5.0 wt. % carbon black or at least 5.1 wt. % carbon black or at least 5.2 wt. % carbon black or at least 5.3 wt. % carbon black or at least 5.4 wt. % carbon black or at least 5.5 wt. % carbon black

Embodiment 20. The blend of embodiment 1, wherein the asphalt blend comprises a carbon black content not greater than 25 wt. % carbon black for a total weight of the blend or not greater than 24 wt. % carbon black or not greater than 23 wt. % carbon black or not greater than 22 wt. % carbon black or not greater than 21 wt. % carbon black or not greater than 20 wt. % carbon black or not greater than 19 wt. % carbon black or not greater than 18 wt. % carbon black or not greater than 17 wt. % carbon black or not greater than 16 wt. % carbon black or not greater than 15 wt. % carbon black or not greater than 14 wt. % carbon black or not greater than 13 wt. % carbon black or not greater than 12 wt. % carbon black or not greater than 11 wt. % carbon black or not greater than 10 wt. % carbon black or not greater than 9 wt. % carbon black or not greater than 8 wt. % carbon black.

Embodiment 21. The blend of embodiment 1, wherein the first polymer additive is a styrene-butadiene-styrene (sbs) polymer.

Embodiment 22. The blend of embodiment 21, wherein the sbs polymer is a linear sbs polymer, a radial sbs polymer, or a combination thereof.

Embodiment 23. The blend of embodiment 21, wherein the sbs polymer is a linear sbs polymer.

Embodiment 24. The blend of embodiment 21, wherein the sbs polymer is a radial sbs polymer.

Embodiment 25. The blend of embodiment 21, wherein the sbs polymer comprises a polybutadiene mid-block vinyl content of at least 5% or at least 6% or at least 7% or at least 8% or at least 9% or at least 10% or at least 11% or at least 12% or at least 13% or at least 14% or at least 15% or at least 16% or at least 17% or at least 18% or at least 19% or at least 20% or at least 21% or at least 22% or at least 23% or at least 24% or at least 25% or at least 26% or at least 27% or at least 28% or at least 29% or at least 30% or at least 31% or at least 32% or at least 33% or at least 34% or at least 35% or at least 36% or at least 37% or at least 38% or at least 39% or at least 40%.

Embodiment 26. The blend of embodiment 21, wherein the sbs polymer comprises a polybutadiene mid-block vinyl content of not greater than 75% or not greater than 60% or not greater than 50% or not greater than 45%.

Embodiment 27. The blend of embodiment 21, wherein the sbs polymer comprises a styrene content of at least 10% or at least 12% or at least 14% or at least 16% or at least 18% or at least 20% or at least 22% or at least 24% or at least 26% or at least 28% or at least 30% or at least 32% or at least 34% or at least 36% or at least 38% or at least 40%.

Embodiment 28. The blend of embodiment 21, wherein the sbs polymer comprises a styrene content of not greater than 50% or not greater than 48% or not greater than 46% or not greater than 44% or not greater than 42% or not greater than 40% or not greater than 38% or not greater than 36% or not greater than 34% or not greater than 32% or not greater than 30%.

Embodiment 29. The blend of embodiment 21, wherein the sbs polymer comprises a molecular weight of at least 180,000 or at least 190,000 or at least 200,000 or at least 210,000 or at least 220,000 or at least 230,000 or at least 240,000 or at least 250,000.

Embodiment 30. The blend of embodiment 21, wherein the sbs polymer comprises a molecular weight of no greater than 320,000 or no greater than 310,000 or no greater than 300,000 or no greater than 290,000.

Embodiment 31. The blend of embodiment 1, wherein the composition comprises a second polymer additive.

Embodiment 32. The blend of embodiment 31, wherein the second polymer additive is a di-block styrene butadiene polymer.

Embodiment 33. The blend of embodiment 31, wherein the second polymer additive is a second sbs polymer.

Embodiment 34. The blend of embodiment 31, wherein the second polymer additive is a linear polymer, a radial polymer, or a combination thereof.

Embodiment 35. The blend of embodiment 31, wherein the second polymer additive is a linear polymer.

Embodiment 36. The blend of embodiment 31, wherein the second polymer additive is a radial polymer.

Embodiment 37. The blend of embodiment 31, wherein the second polymer additive comprises a vinyl content of at least 1% or at least 2% or at least 3% or at least 4% or at least 5% or at least 6% or at least 7% or at least 8% or at least 9% or at least 10% or at least 11% or at least 12% or at least 13% or at least 14% or at least 15% or at least 16% or at least 17% or at least 18% or at least 19% or at least 20% or at least 21% or at least 22% or at least 23% or at least 24% or at least 25% or at least 26% or at least 27% or at least 28% or at least 29% or at least 30% or at least 31% or at least 32% or at least 33% or at least 34% or at least 35% or at least 36% or at least 37% or at least 38% or at least 39% or at least 40%.

Embodiment 38. The blend of embodiment 31, wherein the second polymer additive comprises a vinyl content of not greater than 40% or not greater than 38% or not greater than 36% or not greater than 34% or not greater than 32% or not greater than 30% or not greater than 28% or not greater than 26% or not greater than 24% or not greater than 20% or not greater than 18% or not greater than 26% or not greater than 24% or not greater than 12% or not greater than 10%.

Embodiment 39. The blend of embodiment 31, wherein the second polymer additive comprises a styrene content of at least 1% or at least 2% or at least 3% or at least 4% or at least 5% or at least 6% or at least 7% or at least 8% or at least 9% or at least 10% or at least 11% or at least 12% or at least 13% or at least 14% or at least 15% or at least 16% or at least 17% or at least 18% or at least 19% or at least 20% or at least 21% or at least 22% or at least 23% or at least 24% or at least 25% or at least 26% or at least 27% or at least 28% or at least 29% or at least 30% or at least 31% or at least 32% or at least 33% or at least 34% or at least 35% or at least 36% or at least 37% or at least 38% or at least 39% or at least 40%.

Embodiment 40. The blend of embodiment 31, wherein the second polymer additive comprises a styrene content of not greater than 50% or not greater than 48% or not greater than 46% or not greater than 44% or not greater than 42% or not greater than 40% or not greater than 38% or not greater than 36% or not greater than 34% or not greater than 32% or not greater than 30%.

Embodiment 41. The blend of embodiment 31, wherein the second polymer additive comprises a molecular weight of at least 60,000 or at least 70,000 or at least 80,000 or at least 90,000 or at least 100,000 or at least 110,000 or at least 120,000 or at least 130,000 or at least 140,000 or at least 150,000 or at least 160,000 or at least 170,000 or at least 180,000 or at least 190,000 or at least 200,000 or at least 210,000 or at least 220,000 or at least 230,000 or at least 240,000 or at least 250,000.

Embodiment 42. The blend of embodiment 31, wherein the second polymer additive comprises a molecular weight of no greater than 350,000 or no greater than 340,000 or no greater than 330,000 or no greater than 320,000 or no greater than 310,000 or no greater than 300,000 or no greater than 290,000.

Embodiment 43. The blend of embodiment 31, wherein the asphalt blend comprises a total polymer additive content of at least 1 wt. % polymer additive content for a total weight of the blend or at least 1.5 wt. % polymer additive or at least 2 wt. % polymer additive or at least 2.5 wt. % polymer additive or at least 3 wt. % polymer additive or at least 3.5 wt. % polymer additive or at least 4 wt. % polymer additive or at least 4.5 wt. % polymer additive or at least 5 wt. % polymer additive or at least 5.5 wt. % polymer additive or at least 6 wt. % polymer additive for a total weight of the blend.

Embodiment 44. The blend of embodiment 1, wherein the asphalt blend comprises a total polymer additive content of not greater than 10 wt. % polymer additive for a total weight of the blend or not greater than 9 wt. % polymer additive or not greater than 8 wt. % polymer additive or not greater than 7 wt. % polymer additive or not greater than 6 wt. % polymer additive or not greater than 5 wt. % polymer additive for a total weight of the blend.

Embodiment 45. The blend of embodiment 1, wherein the asphalt blend comprises a first polymer additive content of at least 1 wt. % first polymer additive content for a total weight of the blend or at least 1.5 wt. % first polymer additive or at least 2 wt. % first polymer additive or at least 2.5 wt. % first polymer additive or at least 3 wt. % first polymer additive or at least 3.5 wt. % first polymer additive or at least 4 wt. % first polymer additive or at least 4.5 wt. % first polymer additive or at least 5 wt. % first polymer additive or at least 5.5 wt. % first polymer additive or at least 6 wt. % polymer additive for a total weight of the blend.

Embodiment 46. The blend of embodiment 1, wherein the asphalt blend comprises a first polymer additive content of not greater than 10 wt. % first polymer additive for a total weight of the blend or not greater than 9 wt. % first polymer additive or not greater than 8 wt. % first polymer additive or not greater than 7 wt. % first polymer additive or not greater than 6 wt. % first polymer additive or not greater than 5 wt. % first polymer additive for a total weight of the blend.

Embodiment 47. The blend of embodiment 31, wherein the asphalt blend comprises a second polymer additive content of at least 1 wt. % second polymer additive content for a total weight of the blend or at least 1.5 wt. % second polymer additive or at least 2 wt. % second polymer additive or at least 2.5 wt. % second polymer additive or at least 3 wt. % second polymer additive or at least 3.5 wt. % second polymer additive or at least 4 wt. % second polymer additive or at least 4.5 wt. % second polymer additive or at least 5 wt. % second polymer additive or at least 5.5 wt. % second polymer additive or at least 6 wt. % polymer additive for a total weight of the blend.

Embodiment 48. The blend of embodiment 31, wherein the asphalt blend comprises a second polymer additive content of not greater than 10 wt. % second polymer additive for a total weight of the blend or not greater than 9 wt. % second polymer additive or not greater than 8 wt. % second polymer additive or not greater than 7 wt. % second polymer additive or not greater than 6 wt. % second polymer additive or not greater than 5 wt. % second polymer additive for a total weight of the blend.

Embodiment 49. The blend of embodiment 1, wherein the asphalt blend further comprises a wax.

Embodiment 50. The blend of embodiment 49, wherein the wax comprises a paraffin wax, an alpha olefin wax, a polyamide wax, an ethylene vinyl acetate (EVA) wax, a polypropylene wax, a polyethylene wax, or a combination thereof.

Embodiment 51. The blend of embodiment 49, wherein the wax comprises a polypropylene wax.

Embodiment 52. The blend of embodiment 49, wherein the wax comprises a polyethylene wax.

Embodiment 53. The blend of embodiment 49, wherein the wax comprises a polyethylene wax and a polypropylene wax.

Embodiment 54. The blend of embodiment 49, wherein the wax comprises a recycled wax.

Embodiment 55. The blend of embodiment 49, wherein the asphalt blend comprises a wax content of at least 0.5 wt. % wax for a total weight of the blend or at least 1 wt. % or at least 1.5 wt. % or at least 2 wt. %.

Embodiment 56. The blend of embodiment 49, wherein the asphalt blend comprises a wax content of not greater than 10 wt. % or not greater than 5 wt. % or not greater than 4 wt. % or not greater than 3 wt. % or not greater than 2 wt. %.

Embodiment 57. The blend of any one of embodiments 1-56, wherein the asphalt blend comprises a softening point of at least 200° F. or at least 201° F. or at least 202° F. or at least 203° F. or at least 204° F. or at least 205° F. or at least 206° F. or at least 207° F. or at least 208° F. or at least 209° F. or at least 210° F. or at least 211° F. or at least 212° F. or at least 213° F. or at least 214° F. or at least 215° F. or at least 216° F. or at least 217° F. or at least 218° F. or at least 219° F.

Embodiment 58. The blend of any one of embodiments 1-56, further comprising a softening point of not greater than 300° F. or not greater than 290° F. or not greater than 280° F. or not greater than 270° F. or not greater than 260° F. or not greater than 250° F. or not greater than 240° F. or not greater than 230° F. or not greater than 220° F.

Embodiment 59. The blend of any one of embodiments 1-56, further comprising a penetration at 32° F. of no greater than 20 dmm or no greater than 19 dmm or no greater than 18 dmm or no greater than 17 dmm or no greater than 16 dmm or no greater than 15 dmm or no greater than 14 dmm or no greater than 13 dmm or no greater than 12 dmm or no greater than 11 dmm.

Embodiment 60. The blend of any one of embodiments 1-56, further comprising a penetration at 32° F. of at least 1 dmm or at least 2 dmm or at least 3 dmm or at least 4 dmm or at least 5 dmm or at least 6 dmm or at least 7 dmm or at least 8 dmm or at least 9 dmm or at least 10 dmm or at least 11 dmm.

Embodiment 61. The blend of any one of embodiments 1-56, further comprising a penetration at 77° F. of no greater than 40 dmm or no greater than 39 dmm or no greater than 38 dmm or no greater than 37 dmm or no greater than 36 dmm or no greater than 35 dmm or no greater than 34 dmm or no greater than 33 dmm or no greater than 32 dmm.

Embodiment 62. The blend of any one of embodiments 1-56, further comprising a penetration at 77° F. of at least 21 dmm or at least 22 dmm or at least 23 dmm or at least 24 dmm or at least 25 dmm or at least 26 dmm or at least 27 dmm or at least 28 dmm or at least 29 dmm or at least 30 dmm or at least 31 dmm or at least 32 dmm.

Embodiment 63. The blend of any one of embodiments 1-56, further comprising a penetration at 115° F. of no greater than 88 dmm or no greater than 87 dmm or no greater than 86 dmm or no greater than 85 dmm or no greater than 84 dmm or no greater than 83 dmm or no greater than 82 dmm or no greater than 81 dmm or no greater than 80 dmm or no greater than 79 dmm or no greater than 78 dmm or no greater than 77 dmm or no greater than 76 dmm.

Embodiment 64. The blend of any one of embodiments 1-56, further comprising a penetration at 115° F. of at least 61 dmm or at least 62 dmm or at least 63 dmm or at least 64 dmm or at least 65 dmm or at least 66 dmm or at least 67 dmm or at least 68 dmm or at least 69 dmm or at least 70 dmm or at least 71 dmm or at least 72 dmm or at least 73 dmm or at least 74 dmm or at least 75 dmm or at least 76 dmm.

Embodiment 65. The blend of any one of embodiments 1-56, further comprising a viscosity at 400° F. of at least 300 cps or at least 310 cps or at least 320 cps or at least 330 cps or at least 340 cps or at least 350 cps or at least 360 cps.

Embodiment 66. The blend of any one of embodiments 1-56, further comprising a viscosity at 400° F. of no greater than 1000 cps or no greater than 900 cps or no greater than 800 cps or no greater than 700 cps or no greater than 600 cps or no greater than 500 cps or no greater than 400 cps.

Embodiment 67. The blend of embodiment 13, wherein the sbs polymer comprises a polybutadiene mid-block vinyl content of not greater than 40% or not greater than 38% or not greater than 36% or not greater than 34% or not greater than 32% or not greater than 30% or not greater than 28% or not greater than 26% or not greater than 24% or not greater than 20% or not greater than 18% or not greater than 26% or not greater than 24% or not greater than 12% or not greater than 10%.

Embodiment 68. The blend of embodiment 67, wherein the sbs polymer comprises a polybutadiene mid-block vinyl content at least 1% or at least 2% or at least 3% or at least 4% or at least 5% or at least 6% or at least 7% or at least 8% or at least 9% or at least 10%.

Embodiment 69. The blend of embodiment 67, wherein the asphalt blend has a carbon black content of at least 2.1 wt. % carbon black or at least 2.2 wt. % carbon black or at least 2.3 wt. % carbon black or at least 2.4 wt. % carbon black or at least 2.5 wt. % carbon black or at least 2.6 wt. % carbon black or at least 2.7 wt. % carbon black or at least 2.8 wt. % carbon black or at least 2.9 wt. % carbon black or at least 3.0 wt. % carbon black or at least 3.1 wt. % carbon black or at least 3.2 wt. % carbon black or at least 3.3 wt. % carbon black or at least 3.4 wt. % carbon black or at least 3.5 wt. % carbon black or at least 3.6 wt. % carbon black or at least 3.7 wt. % carbon black or at least 3.8 wt. % carbon black or at least 3.9 wt. % carbon black or at least 4.0 wt. % carbon black.

Embodiment 70. The blend of embodiment 67, wherein the asphalt blend has a carbon black content of not greater than 25 wt. % carbon black for a total weight of the blend or not greater than 24 wt. % carbon black or not greater than 23 wt. % carbon black or not greater than 22 wt. % carbon black or not greater than 21 wt. % carbon black or not greater than 20 wt. % carbon black or not greater than 19 wt. % carbon black or not greater than 18 wt. % carbon black or not greater than 17 wt. % carbon black or not greater than 16 wt. % carbon black or not greater than 15 wt. % carbon black or not greater than 14 wt. % carbon black or not greater than 13 wt. % carbon black or not greater than 12 wt. % carbon black or not greater than 11 wt. % carbon black or not greater than 10 wt. % carbon black or not greater than 9 wt. % carbon black or not greater than 8 wt. % carbon black.

Embodiment 71. The blend of embodiment 67, wherein the asphalt blend has a softening point of at least 204° F. or at least 205° F. or at least 206° F.

Embodiment 72. The blend of embodiment 67, wherein the asphalt blend has a softening point of not greater than 300° F. or not greater than 290° F. or not greater than 280° F. or not greater than 270° F. or not greater than 260° F. or not greater than 250° F. or not greater than 240° F. or not greater than 230° F. or not greater than 220° F.

Embodiment 73. The blend of embodiment 67, comprising a penetration at 32° F. of no greater than 15 dmm or no greater than 14 dmm.

Embodiment 74. The blend of embodiment 67, comprising a penetration at 32° F. of at least 1 dmm or at least 2 dmm or at least 3 dmm or at least 4 dmm or at least 5 dmm or at least 6 dmm or at least 7 dmm or at least 8 dmm or at least 9 dmm or at least 10 dmm or at least 11 dmm.

Embodiment 75. The blend of embodiment 67, comprising a penetration at 77° F. of no greater than 37 dmm or no greater than 36 dmm or no greater than 35 dmm or no greater than 34 dmm or no greater than 33 dmm.

Embodiment 76. The blend of embodiment 67, comprising a penetration at 77° F. of at least 21 dmm or at least 22 dmm or at least 23 dmm or at least 24 dmm or at least 25 dmm or at least 26 dmm or at least 27 dmm or at least 28 dmm or at least 29 dmm or at least 30 dmm or at least 31 dmm or at least 32 dmm.

Embodiment 77. The blend of embodiment 67, comprising a penetration at 115° F. of no greater than 88 dmm or no greater than 87 dmm or no greater than 86 dmm or no greater than 85 dmm or no greater than 84 dmm or no greater than 83 dmm or no greater than 82 dmm or no greater than 81 dmm or no greater than 80 dmm or no greater than 79 dmm or no greater than 78 dmm or no greater than 77 dmm or no greater than 76 dmm.

Embodiment 78. The blend of embodiment 67, comprising a penetration at 115° F. of at least 61 dmm or at least 62 dmm or at least 63 dmm or at least 64 dmm or at least 65 dmm or at least 66 dmm or at least 67 dmm or at least 68 dmm or at least 69 dmm or at least 70 dmm or at least 71 dmm or at least 72 dmm or at least 73 dmm or at least 74 dmm or at least 75 dmm or at least 76 dmm.

Embodiment 79. The blend of embodiment 67, comprising a viscosity at 400° F. of at least 300 cps or at least 310 cps or at least 320 cps or at least 330 cps or at least 340 cps or at least 350 cps or at least 360 cps.

Embodiment 80. The blend of embodiment 67, comprising a comprising a viscosity at 400° F. of no greater than 1000 cps or no greater than 900 cps or no greater than 800 cps or no greater than 700 cps or no greater than 600 cps or no greater than 500 cps or no greater than 400 cps.

Embodiment 81. The blend of embodiment 13, wherein the sbs polymer comprises a polybutadiene mid-block vinyl content of at least 10% or at least 11% or at least 12% or at least 13% or at least 14% or at least 15% or at least 16% or at least 17% or at least 18% or at least 19% or at least 20% or at least 21% or at least 22% or at least 23% or at least 24% or at least 25% or at least 26% or at least 27% or at least 28% or at least 29% or at least 30% or at least 31% or at least 32% or at least 33% or at least 34% or at least 35% or at least 36% or at least 37% or at least 38% or at least 39% or at least 40%.

Embodiment 82. The blend of embodiment 81, wherein the sbs polymer comprises a polybutadiene mid-block vinyl content of not greater than 75% or not greater than 60% or not greater than 50% or not greater than 45%.

Embodiment 83. The blend of embodiment 81, wherein the asphalt blend has a carbon black content of at least 4.1 wt. % carbon black or at least 4.2 wt. % carbon black or at least 4.3 wt. % carbon black or at least 4.4 wt. % carbon black or at least 4.5 wt. % carbon black or at least 4.6 wt. % carbon black or at least 4.7 wt. % carbon black or at least 4.8 wt. % carbon black or at least 4.9 wt. % carbon black or at least 5.0 wt. % carbon black or at least 5.1 wt. % carbon black or at least 5.2 wt. % carbon black or at least 5.3 wt. % carbon black or at least 5.4 wt. % carbon black or at least 5.5 wt. % carbon black or at least 5.6 wt. % carbon black or at least 5.7 wt. % carbon black or at least 5.8 wt. % carbon black or at least 5.9 wt. % carbon black or at least 6.0 wt. % carbon black.

Embodiment 84. The blend of embodiment 81, wherein the asphalt blend has a carbon black content of not greater than 25 wt. % carbon black for a total weight of the blend or not greater than 24 wt. % carbon black or not greater than 23 wt. % carbon black or not greater than 22 wt. % carbon black or not greater than 21 wt. % carbon black or not greater than 20 wt. % carbon black or not greater than 19 wt. % carbon black or not greater than 18 wt. % carbon black or not greater than 17 wt. % carbon black or not greater than 16 wt. % carbon black or not greater than 15 wt. % carbon black or not greater than 14 wt. % carbon black or not greater than 13 wt. % carbon black or not greater than 12 wt. % carbon black or not greater than 11 wt. % carbon black or not greater than 10 wt. % carbon black or not greater than 9 wt. % carbon black or not greater than 8 wt. % carbon black.

Embodiment 85. The blend of embodiment 81, wherein the asphalt blend has a softening point of at least 209° F. or at least 210° F. or at least 211° F. or at least 212° F. or at least 213° F. or at least 214° F. or at least 215° F. or at least 216° F. or at least 217° F. or at least 218° F. or at least 219° F.

Embodiment 86. The blend of embodiment 81, wherein the asphalt blend has a softening point of not greater than 300° F. or not greater than 290° F. or not greater than 280° F. or not greater than 270° F. or not greater than 260° F. or not greater than 250° F. or not greater than 240° F. or not greater than 230° F. or not greater than 220° F.

Embodiment 87. The blend of embodiment 81, comprising a penetration at 32° F. of no greater than 15 dmm or no greater than 14 dmm or no greater than 13 dmm or no greater than 12 dmm or no greater than 11 dmm.

Embodiment 88. The blend of embodiment 81, comprising a penetration at 32° F. of at least 1 dmm or at least 2 dmm or at least 3 dmm or at least 4 dmm or at least 5 dmm or at least 6 dmm or at least 7 dmm or at least 8 dmm or at least 9 dmm or at least 10 dmm or at least 11 dmm.

Embodiment 89. The blend of embodiment 81, comprising a penetration at 77° F. of no greater than 37 dmm or no greater than 36 dmm or no greater than 35 dmm or no greater than 34 dmm or no greater than 33 dmm or no greater than 32 dmm.

Embodiment 90. The blend of embodiment 81, comprising a penetration at 77° F. of at least 21 dmm or at least 22 dmm or at least 23 dmm or at least 24 dmm or at least 25 dmm or at least 26 dmm or at least 27 dmm or at least 28 dmm or at least 29 dmm or at least 30 dmm or at least 31 dmm or at least 32 dmm.

Embodiment 91. The blend of embodiment 81, comprising a penetration at 115° F. of no greater than 88 dmm or no greater than 87 dmm or no greater than 86 dmm or no greater than 85 dmm or no greater than 84 dmm or no greater than 83 dmm or no greater than 82 dmm or no greater than 81 dmm or no greater than 80 dmm or no greater than 79 dmm.

Embodiment 92. The blend of embodiment 81, comprising a penetration at 115° F. of at least 61 dmm or at least 62 dmm or at least 63 dmm or at least 64 dmm or at least 65 dmm or at least 66 dmm or at least 67 dmm or at least 68 dmm or at least 69 dmm or at least 70 dmm or at least 71 dmm or at least 72 dmm or at least 73 dmm or at least 74 dmm or at least 75 dmm or at least 76 dmm.

Embodiment 93. The blend of embodiment 81, comprising a viscosity at 400° F. of at least 300 cps or at least 310 cps or at least 320 cps or at least 330 cps or at least 340 cps or at least 350 cps or at least 360 cps or at least 370 cps.

Embodiment 94. The blend of embodiment 81, comprising a comprising a viscosity at 400° F. of no greater than 1000 cps or no greater than 900 cps or no greater than 800 cps or no greater than 700 cps or no greater than 600 cps or no greater than 500 cps or no greater than 400 cps.

Embodiment 95. A method of preparing an asphalt blend according to any one of embodiments 1-94, providing the asphalt, polymer additive, and carbon black, and optionally a wax, mixing the asphalt, polymer additive, and carbon black to prepare an asphalt blend.

Embodiment 96. The method of embodiment 95, wherein mixing to prepare an asphalt blend is done at a temperature of at least 325° F. or at least 330° F. or at least 345° F. or at least 350° F. or at least 355° F. or at least 360° F. or at least 365° F.

Embodiment 97. The method of embodiment 95, wherein mixing to prepare an asphalt blend is done at a temperature of no greater than 425° F. or no greater than 420° F. or no greater than 415° F. or no greater than 410° F. or no greater than 405° F. or no greater than 400° F. or no greater than 395° F. or no greater than 390° F. or no greater than 385° F.

Embodiment 98. The method of embodiment 95, wherein mixing to prepare an asphalt blend is done with high shear mixing.

Embodiment 99. The method of embodiment 95, wherein mixing to prepare an asphalt blend is done with a homogenizer or rotor stator mixer.

Embodiment 100. The method of embodiment 99, wherein the homogenizer or rotor stator mixer is operated with a speed of at least 2500 rpm or at least 2600 rpm or at least 2700 rpm or at least 2800 rpm or at least 2900 rpm or at least 3000 rpm.

Embodiment 101. The method of embodiment 99, wherein the homogenizer or rotor stator mixer is operated with a speed of no greater than 4500 rpm or no greater than 4400 rpm or no greater than 4300 rpm or no greater than 4200 rpm or no greater than 4100 rpm or no greater than 4000 rpm.

Embodiment 102. A filled asphalt mix comprising:
an asphalt blend comprising:
asphalt,
a first polymer additive, and
   carbon black
filler;
   the filled asphalt mix having a softening point of at least 250° F., a penetration at 115° F. of less than or equal to 33 dmm, or an NAF of not greater than 1.0 PLI.

Embodiment 103. The mix of embodiment 102, wherein the blend comprises a blend according to any one of embodiments 1-94.

Embodiment 104. The mix of embodiment 102, wherein the mix comprises an NAF of not greater than 1.0 PLI or not greater than 0.95 PLI or not greater than 0.90 PLI or not greater than 0.85 PLI or not greater than 0.80 PLI or not greater than 0.75 PLI or not greater than 0.70 PLI or not greater than 0.65 PLI or not greater than 0.60 PLI or not greater than 0.55 PLI or not greater than 0.50 PLI or not greater than 0.45 PLI or not greater than 0.40 PLI or not greater than 0.35 PLI or not greater than 0.35 PLI.

Embodiment 105. The mix of embodiment 102, wherein the mix comprises an NAF of at least 0.05 PLI or at least 0.10 PLI or at least 0.15 PLI or at least 0.20 PLI.

Embodiment 106. The mix of embodiment 102, wherein the filler comprises CaCO₃.

Embodiment 107. The mix of embodiment 102, wherein the filler comprises limestone.

Embodiment 108. The mix of embodiment 102, wherein the composition comprises a filler content of at least 40 wt. % filler for a total weight of the mix or at least 42 wt. % or at least 44 wt. % or at least 46 wt. % or at least 48 wt. % or at least 50 wt. % or at least 52 wt. % or at least 54 wt. % or at least 56 wt. % or at least 58 wt. % or at least 60 wt. % or at least 62 wt. % or at least 64 wt. % or at least 66 wt. % or at least 68 wt. % or at least 70 wt. % or at least 72 wt. % or at least 74 wt. % or at least 76 wt. % or at least 78 wt. % or at least 80 wt. %.

Embodiment 109. The mix of embodiment 102, wherein the composition comprises a filler content of not greater than 90 wt. % filler for a total weight of the mix or not greater than 88 wt. % or not greater than 86 wt. % or not greater than 84 wt. % or not greater than 82 wt. % or not greater than 80 wt. % or not greater than 78 wt. % or not greater than 76 wt. % or not greater than 74 wt. % or not greater than 72 wt. % or not greater than 70 wt. %.

Embodiment 110. The mix of embodiment 102, wherein the asphalt mix comprises a softening point of at least 250° F. or at least 251° F. or at least 252° F. or at least 253° F. or at least 254° F. or at least 255° F. or at least 256° F. or at least 257° F. or at least 258° F. or at least 259° F. or at least 260° F. or at least 261° F. or at least 262° F. or at least 263° F. or at least 264° F. or at least 265° F. or at least 266° F. or at least 267° F. or at least 268° F. or at least 269° F. or at least 270° F. or at least 271° F. or at least 272° F. or at least 273° F. or at least 274° F. or at least 275° F. or at least 276° F. or at least 277° F. or at least 278° F. or at least 279° F. or at least 280° F.

Embodiment 111. The mix of embodiment 102, further comprising a softening point of not greater than 325° F. or not greater than 320° F. or not greater than 315° F. or not greater than 310° F. or not greater than 305° F. or not greater than 300° F. or not greater than 295° F. or not greater than 290° F.

Embodiment 112. The mix of embodiment 102, further comprising a penetration at 32° F. of no greater than 10 dmm or no greater than 9 dmm or no greater than 8 dmm or no greater than 7 dmm or no greater than 6 dmm.

Embodiment 113. The mix of embodiment 102, further comprising a penetration at 32° F. of at least 1 dmm or at least 2 dmm or at least 3 dmm or at least 4 dmm or at least 5 dmm or at least 6 dmm or at least 7 dmm.

Embodiment 114. The mix of embodiment 102, further comprising a penetration at 77° F. of no greater than 20 dmm or no greater than 19 dmm or no greater than 18 dmm or no greater than 17 dmm or no greater than 16 dmm or no greater than 15 dmm or no greater than 14 dmm or no greater than 13 dmm or no greater than 12 dmm.

Embodiment 115. The mix of embodiment 102, further comprising a penetration at 77° F. of at least 1 dmm or at least 2 dmm or at least 3 dmm or at least 4 dmm or at least 5 dmm or at least 6 dmm or at least 7 dmm or at least 8 dmm or at least 9 dmm or at least 10 dmm or at least 11 dmm or at least 12 dmm.

Embodiment 116. The mix of embodiment 102, further comprising a penetration at 115° F. of no greater than 40 dmm or no greater than 39 dmm or no greater than 38 dmm or no greater than 37 dmm or no greater than 36 dmm or no greater than 35 dmm or no greater than 34 dmm or no greater than 33 dmm or no greater than 32 dmm.

Embodiment 117. The mix of embodiment 102, further comprising a penetration at 115° F. of at least 21 dmm or at least 22 dmm or at least 23 dmm or at least 24 dmm or at least 25 dmm or at least 26 dmm or at least 27 dmm or at least 28 dmm or at least 29 dmm or at least 30 dmm or at least 31 dmm or at least 32 dmm.

Embodiment 118. The mix of embodiment 102, further comprising a viscosity at 400° F. of at least 3600 cps or at least 3700 cps or at least 3800 cps or at least 3900 cps or at least 4000 cps or at least 4100 cps or at least 4200 cps or at least 4300 cps or at least 4400 cps or at least 4500 cps or at least 4600 cps or at least 4700 cps or at least 4800 cps or at least 4900 cps or at least 5000 cps or at least 5100 cps or at least 5200 cps or at least 5300 cps.

Embodiment 119. The mix of embodiment 102, further comprising a viscosity at 400° F. of no greater than 10000 cps or no greater than 9000 cps or no greater than 8000 cps or no greater than 7000 cps or no greater than 6000 cps or no greater than 5000 cps.

Embodiment 120. The mix of embodiment 102, further comprising a weatherability of at least 30 days or at least 40 days or at least 50 days or at least 60 days or at least 70 days or at least 80 days or at least 90 days or at least 100 days or at least 110 days or at least 120 days or at least 130 days or at least 140 days or at least 150 days or at least 160 days or at least 70 days or at least 180 days or at least 190 days or at least 200 days.

Embodiment 121. The mix of embodiment 102, further comprising a weatherability of not greater than 1000 days.

Embodiment 122. The mix of embodiment 102, wherein the first polymer additive comprises an sbs polymer with a polybutadiene mid-block vinyl of not greater than 40% or not greater than 38% or not greater than 36% or not greater than 34% or not greater than 32% or not greater than 30% or not greater than 28% or not greater than 26% or not greater than 24% or not greater than 20% or not greater than 18% or not greater than 26% or not greater than 24% or not greater than 12% or not greater than 10%.

Embodiment 123. The mix of embodiment 122, wherein the sbs polymer comprises a polybutadiene mid-block vinyl content at least 1% or at least 2% or at least 3% or at least 4% or at least 5% or at least 6% or at least 7% or at least 8% or at least 9% or at least 10%.

Embodiment 124. The mix of embodiment 122, wherein the asphalt blend has a carbon black content of at least 2.1 wt. % carbon black or at least 2.2 wt. % carbon black or at least 2.3 wt. % carbon black or at least 2.4 wt. % carbon black or at least 2.5 wt. % carbon black or at least 2.6 wt. % carbon black or at least 2.7 wt. % carbon black or at least 2.8 wt. % carbon black or at least 2.9 wt. % carbon black or at least 3.0 wt. % carbon black or at least 3.1 wt. % carbon black or at least 3.2 wt. % carbon black or at least 3.3 wt. % carbon black or at least 3.4 wt. % carbon black or at least 3.5 wt. % carbon black or at least 3.6 wt. % carbon black or at least 3.7 wt. % carbon black or at least 3.8 wt. % carbon black or at least 3.9 wt. % carbon black or at least 4.0 wt. % carbon black.

Embodiment 125. The mix of embodiment 122, wherein the asphalt blend has a carbon black content of not greater than 25 wt. % carbon black for a total weight of the blend or not greater than 24 wt. % carbon black or not greater than 23 wt. % carbon black or not greater than 22 wt. % carbon black or not greater than 21 wt. % carbon black or not greater than 20 wt. % carbon black or not greater than 19 wt. % carbon black or not greater than 18 wt. % carbon black or not greater than 17 wt. % carbon black or not greater than 16 wt. % carbon black or not greater than 15 wt. % carbon black or not greater than 14 wt. % carbon black or not greater than 13 wt. % carbon black or not greater than 12 wt. % carbon black or not greater than 11 wt. % carbon black or not greater than 10 wt. % carbon black or not greater than 9 wt. % carbon black or not greater than 8 wt. % carbon black.

Embodiment 126. The mix of embodiment 122, wherein the mix comprises a softening point of at least 250° F. or at least 251° F. or at least 252° F. or at least 253° F. or at least 254° F. or at least 255° F. or at least 256° F.

Embodiment 127. The mix of embodiment 122, comprising a softening point of not greater than 325° F. or not greater than 320° F. or not greater than 315° F. or not greater than 310 OF or not greater than 305° F. or not greater than 300° F. or not greater than 295° F. or not greater than 290° F.

Embodiment 128. The mix of embodiment 122, comprising a penetration at 32° F. of no greater than 9 dmm or no greater than 8 dmm or no greater than 7 dmm.

Embodiment 129. The mix of embodiment 122, comprising a penetration at 32° F. of at least 1 dmm or at least 2 dmm or at least 3 dmm or at least 4 dmm or at least 5 dmm or at least 6 dmm or at least 7 dmm.

Embodiment 130. The mix of embodiment 122, comprising a penetration at 77° F. of no greater than 20 dmm or no greater than 19 dmm or no greater than 18 dmm or no greater than 17 dmm or no greater than 16 dmm or no greater than 15 dmm or no greater than 14 dmm or no greater than 13 dmm.

Embodiment 131. The mix of embodiment 122, comprising a penetration at 77° F. of at least 1 dmm or at least 2 dmm or at least 3 dmm or at least 4 dmm or at least 5 dmm or at least 6 dmm or at least 7 dmm or at least 8 dmm or at least 9 dmm or at least 10 dmm or at least 11 dmm or at least 12 dmm.

Embodiment 132. The mix of embodiment 122, comprising a penetration at 115° F. of no greater than 37 dmm or no greater than 36 dmm or no greater than 35 dmm or no greater than 34 dmm or no greater than 33 dmm or no greater than 32 dmm.

Embodiment 133. The mix of embodiment 122, comprising a penetration at 115° F. of at least 21 dmm or at least 22 dmm or at least 23 dmm or at least 24 dmm or at least 25 dmm or at least 26 dmm or at least 27 dmm or at least 28 dmm or at least 29 dmm or at least 30 dmm or at least 31 dmm or at least 32 dmm.

Embodiment 134. The mix of embodiment 122, comprising a viscosity at 400° F. of at least 3600 cps or at least 3700 cps or at least 3800 cps or at least 3900 cps or at least 4000 cps or at least 4100 cps or at least 4200 cps or at least 4300 cps or at least 4400 cps.

Embodiment 135. The mix of embodiment 122, comprising a viscosity at 400° F. of no greater than 10000 cps or no greater than 9000 cps or no greater than 8000 cps or no greater than 7000 cps or no greater than 6000 cps or no greater than 5000 cps.

Embodiment 136. The mix of embodiment 102, wherein the first polymer additive comprises wherein the sbs polymer comprises a polybutadiene mid-block vinyl content of at least 10% or at least 11% or at least 12% or at least 13% or at least 14% or at least 15% or at least 16% or at least 17% or at least 18% or at least 19% or at least 20% or at least 21% or at least 22% or at least 23% or at least 24% or at least 25% or at least 26% or at least 27% or at least 28% or at least 29% or at least 30% or at least 31% or at least 32% or at least 33% or at least 34% or at least 35% or at least 36% or at least 37% or at least 38% or at least 39% or at least 40%.

Embodiment 137. The mix of embodiment 136, wherein the sbs polymer comprises a polybutadiene mid-block vinyl content of not greater than 75% or not greater than 60% or not greater than 50% or not greater than 45%.

Embodiment 138. The mix of embodiment 136, wherein the asphalt blend has a carbon black content of at least 4.1 wt. % carbon black or at least 4.2 wt. % carbon black or at least 4.3 wt. % carbon black or at least 4.4 wt. % carbon black or at least 4.5 wt. % carbon black or at least 4.6 wt. % carbon black or at least 4.7 wt. % carbon black or at least 4.8 wt. % carbon black or at least 4.9 wt. % carbon black or at least 5.0 wt. % carbon black or at least 5.1 wt. % carbon black or at least 5.2 wt. % carbon black or at least 5.3 wt. % carbon black or at least 5.4 wt. % carbon black or at least 5.5 wt. % carbon black or at least 5.6 wt. % carbon black or at least 5.7 wt. % carbon black or at least 5.8 wt. % carbon black or at least 5.9 wt. % carbon black or at least 6.0 wt. % carbon black.

Embodiment 139. The mix of embodiment 136, wherein the asphalt blend has a carbon black content of not greater than 25 wt. % carbon black for a total weight of the blend or not greater than 24 wt. % carbon black or not greater than 23 wt. % carbon black or not greater than 22 wt. % carbon black or not greater than 21 wt. % carbon black or not greater than 20 wt. % carbon black or not greater than 19 wt. % carbon black or not greater than 18 wt. % carbon black or not greater than 17 wt. % carbon black or not greater than 16 wt. % carbon black or not greater than 15 wt. % carbon black or not greater than 14 wt. % carbon black or not greater than 13 wt. % carbon black or not greater than 12 wt. % carbon black or not greater than 11 wt. % carbon black or not greater than 10 wt. % carbon black or not greater than 9 wt. % carbon black or not greater than 8 wt. % carbon black.

Embodiment 140. The mix of embodiment 136, wherein the mix comprises a softening point of at least 267° F. or at least 268° F. or at least 269° F. or at least 270° F. or at least 271° F. or at least 272° F. or at least 273° F. or at least 274° F. or at least 275° F. or at least 276° F.

Embodiment 141. The mix of embodiment 136, comprising a softening point of not greater than 325° F. or not greater than 320° F. or not greater than 315° F. or not greater than 310 OF or not greater than 305° F. or not greater than 300° F. or not greater than 295° F. or not greater than 290° F.

Embodiment 142. The mix of embodiment 136, comprising a penetration at 32° F. of no greater than 9 dmm or no greater than 8 dmm or no greater than 7 dmm or no greater than 6 dmm.

Embodiment 143. The mix of embodiment 136, comprising a penetration at 32° F. of at least 1 dmm or at least 2 dmm or at least 3 dmm or at least 4 dmm or at least 5 dmm or at least 6 dmm or at least 7 dmm.

Embodiment 144. The mix of embodiment 136, comprising a penetration at 77° F. of no greater than 17 dmm or no greater than 16 dmm or no greater than 15 dmm or no greater than 14 dmm or no greater than 13 dmm or no greater than 12 dmm.

Embodiment 145. The mix of embodiment 136, comprising a penetration at 77° F. of at least 1 dmm or at least 2 dmm or at least 3 dmm or at least 4 dmm or at least 5 dmm or at least 6 dmm or at least 7 dmm or at least 8 dmm or at least 9 dmm or at least 10 dmm or at least 11 dmm or at least 12 dmm.

Embodiment 146. The mix of embodiment 136, comprising a penetration at 115° F. of no greater than 40 dmm or no greater than 39 dmm or no greater than 38 dmm or no greater than 37 dmm or no greater than 36 dmm or no greater than 35 dmm or no greater than 34 dmm or no greater than 33 dmm or no greater than 32 dmm.

Embodiment 147. The mix of embodiment 136, comprising a penetration at 115° F. of at least 21 dmm or at least 22 dmm or at least 23 dmm or at least 24 dmm or at least 25 dmm or at least 26 dmm or at least 27 dmm or at least 28 dmm or at least 29 dmm or at least 30 dmm or at least 31 dmm or at least 32 dmm.

Embodiment 148. The mix of embodiment 136, comprising a viscosity at 400° F. of at least 3600 cps or at least 3700 cps or at least 3800 cps or at least 3900 cps or at least 4000 cps or at least 4100 cps or at least 4200 cps or at least 4300 cps or at least 4400 cps or at least 4500 cps or at least 4600 cps or at least 4700 cps or at least 4800 cps or at least 4900 cps or at least 5000 cps or at least 5100 cps or at least 5200 cps or at least 5300 cps.

Embodiment 149. The mix of embodiment 136, comprising a viscosity at 400° F. of no greater than 10000 cps or no greater than 9000 cps or no greater than 8000 cps or no greater than 7000 cps or no greater than 6000 cps or no greater than 5000 cps.

Embodiment 150. A method of preparing a filled asphalt mix according to any one of embodiments 102-149, providing the asphalt, polymer additive, and carbon black, and optionally a wax, mixing the asphalt, polymer additive, and carbon black to prepare an asphalt blend, providing a filler, mixing the asphalt blend and the filler to prepare a filled asphalt mix.

Embodiment 151. The method of embodiment 150, wherein the asphalt blend comprises the blend of any of embodiments 1-86.

Embodiment 152. The method of embodiment 150, wherein mixing to prepare an asphalt blend is done at a temperature of at least 325° F. or at least 330° F. or at least 345° F. or at least 350° F. or at least 355° F. or at least 360° F. or at least 365° F.

Embodiment 153. The method of embodiment 150, wherein mixing to prepare an asphalt blend is done at a temperature of no greater than 425° F. or no greater than 420° F. or no greater than 415° F. or no greater than 410° F. or no greater than 405° F. or no greater than 400° F. or no greater than 395° F. or no greater than 390° F. or no greater than 385° F.

Embodiment 154. The method of embodiment 150, wherein mixing to prepare a filled asphalt mix is done at a temperature of at least 350° F. or at least 360° F. or at least 370° F. or at least 380° F. or at least 390° F.

Embodiment 155. The method of embodiment 150, wherein mixing to prepare a filled asphalt mix is done at a temperature of no greater than 450° F. or no greater than 440° F. or no greater than 430° F. or no greater than 420° F. or no greater than 410° F.

Embodiment 156. A roofing shingle comprising:
a fiberglass mat;
an asphalt composition coating the fiberglass mat, the composition comprising the asphalt mix of any one of embodiments 102-149.

Embodiment 157. A bundle of packaged roofing shingles according to embodiment 156.

Embodiment 158. The bundle of embodiment 157, comprising at least 10 shingles or at least 11 shingles or at least 12 shingles or at least 13 shingles or at least 14 shingles or at least 15 shingles or at least 16 shingles or at least 17 shingles or at least 18 shingles or at least 19 shingles or at least 20 shingles.

Embodiment 159. The bundle of embodiment 157, comprising no greater than 30 shingles or no greater than 28 shingles or no greater than 26 shingles or no greater than 24 shingles or no greater than 22 shingles.

Embodiment 160. A palleted plurality of roofing shingles comprising a plurality of roofing shingles disposed in one or more stacks on a pallet, wherein the pallet has a top surface formed of a plurality of top boards, and wherein:
(a) adjacent boards of the plurality of top boards have a gap of no more than one inch therebetween at the top surfaces thereof; and/or
(b) the plurality of top boards take up at least 85% of the occluded area of the top surface of the pallet;
(c) each of the plurality of top boards has a thickness of at least 0.55 inches, and wherein each roofing shingle has an upper edge, a lower edge, a first end, and a second end, each roofing shingle comprising a shingle according to embodiment 156.

Embodiment 161. The palleted plurality of roofing shingles of embodiment 160, where the stacks of shingles comprise bundles of shingles according to embodiments 157-159.

Embodiment 162. The palleted plurality of roofing shingles of embodiment 160, wherein the one or more stacks comprise 3-5 stacks.

Embodiment 163. The palleted plurality of roofing shingles of embodiment 160, wherein the one or more stacks comprise 4 stacks.

Embodiment 164. The palleted plurality of roofing shingles of embodiment 161, wherein each stack comprises at least 6 bundles or at least 7 bundles or at least 8 bundles or at least 9 bundles or at least 10 bundles or at least 11 bundles or at least 12 bundles.

Embodiment 165. The palleted plurality of roofing shingles of embodiment 161, wherein each stack comprises no greater than 16 bundles or no greater than 15 bundles or no greater than 14 bundles or no greater than 13 bundles or no greater than 12 bundles.

### EXAMPLES

### Example 1—Carbon Black Compositions

A standard American Stainless-Steel quart can Dimensions: 4.25″ Dia.×4.875″ H was partially filled with 300 g paving grade PG 64-22 asphalt. The can and asphalt were then heated to a temperature of at least 350° F. and mixed using a Greerco 1 L-87 ½HP High Shear homogenizer/rotor stator mixer (Greerco 1 L-87 ½HP High Shear) and mixed on low power to heat the mixing head. Polymer, waxes, and carbon black were added according to table 2 below. The wax was a recycled polyethylene wax. Various SBS polymers were used having specifications according to table 1 below.

TABLE 1

| | SBS 1 | SBS 2 |
|---|---|---|
| Structure | Radial, triblock | Radial, triblock |
| Styrene content (%) | 35% | 30% |
| Vinyl content (%) | 40% | 10% |

The minimum temperature was increased to 365° F. and the blend was mixed for 1 hour at 3000 to 4000 rpm. During mixing, the temperature was kept within a range of 365° F. to 385° F.

Proper mixing can be confirmed by using a UV microscope to determine if a polymer network is fully formed. Proper mixing can also be tested using a smear test where a sample is spread across a flat surface to determine if there are any unmixed particles.

Filled examples and comparative examples were be prepared by adding CaCO₃ to the blends of asphalt, polymer, wax, and carbon black according to table 2 and the following process. CaCO₃ and the asphalt mixture were heated to a temperature of 400-415° F. for at least 1 hour. The heated filler was then added to the unfilled asphalt blend and mixed for 15 minutes with an angled paddle blade mixer at 700 RPM for at least 15 minutes to produce filled examples and comparative examples. The mixer was a FisherBrand™ Overhead Stirrer MFR Num 14-500-210 equipped with a Caframo Pitched Blade 2″ diameter Turbine (Mfr #5080156).

Filled asphalt mixes and asphalt blends were evaluated for softening point, penetration, viscosity, and weatherability according to the standard methods in table 3 below.

TABLE 2
Filled Asphalt Mixes

| | | | | | | | | |
|---|---|---|---|---|---|---|---|---|
| Sample | CS1 | CS2 | S1 | CS3 | CS4 | CS5 | S2a | S2b |

Asphalt Blend Composition

| | | | | | | | | |
|---|---|---|---|---|---|---|---|---|
| PG 64-22 Asphalt | 92.0% | 90.0% | 88.0% | 92.0% | 90.0% | 88.0% | 86.0% | 86.0% |
| SBS 2 | 5.5% | 5.5% | 5.5% | 0% | 0% | 0% | 0% | 0% |
| SBS 1 | 0% | 0% | 0% | 5.5% | 5.5% | 5.5% | 5.5% | 5.5% |
| Wax | 2.5% | 2.5% | 2.5% | 2.5% | 2.5% | 2.5% | 2.5% | 2.5% |
| Carbon Black | 0% | 2.0% | 4.0% | 0% | 2.0% | 4.0% | 6% | 6% |

Asphalt Blend Characteristics

| | | | | | | | | |
|---|---|---|---|---|---|---|---|---|
| S. Pt. (F.) | 204.8 | 204.2 | 206.1 | 208.4 | 211.2 | 219.3 | 219.4 | 219.4 |
| 32° F. Pen (dmm) | 15 | 14 | 14 | 14 | 14 | 14 | 11 | 11 |
| 77° F. Pen (dmm) | 39 | 37 | 33 | 37 | 33 | 32 | 32 | 32 |
| 115°F. Pen (dmm) | 88 | 86 | 76 | 88 | 78 | 78 | 79 | 79 |
| Vis. @ 400° F. (cps) | 287 | 300 | 363 | 250 | 275 | 262 | 375 | 375 |

Filled Asphalt Mix Composition

| | | | | | | | | |
|---|---|---|---|---|---|---|---|---|
| Asphalt Blend | 34% | 34% | 34% | 34% | 34% | 34% | 34% | 32% |
| CaCO₃ | 66% | 66% | 66% | 66% | 66% | 66% | 66% | 68% |

Filled Asphalt Mix Characteristics

| | | | | | | | | |
|---|---|---|---|---|---|---|---|---|
| S. Pt. (F.) | 249.9 | 256.5 | 256.9 | 267.3 | 268.9 | 268.7 | 276.4 | 278.7 |
| 32° F. Pen (dmm) | 9 | 7 | 7 | 8 | 7 | 5 | 6 | |
| 77° F. Pen (dmm) | 17 | 16 | 13 | 18 | 14 | 12 | 14 | 12 |
| 115° F. Pen (dmm) | 34 | 37 | 32 | 41 | 34 | 34 | 32 | |
| Vis. @ 400° F. (cps) | 3540 | 4,200 | 4,490 | 3,000 | 3,210 | 3,900 | 5,400 | 6350 |
| WOM | 27 | 86 | 86 | 65 | 126 | 400+ | 400+ | 400+ |

TABLE 3

| Test | ASTM Code | Test Name |
|---|---|---|
| Penetration | ASTM D5-06 | Standard Test Method for Penetration of Bituminous |
| | | Materials |
| Softening | ASTM | Standard Test Method for Softening Point of Asphalt and |
| Point | D3461-18 | Pitch (Mettler Cup-and-Ball Method) |
| Viscosity | ASTM | Standard Test Method for Viscosity Determination of Asphalt |
| | D4402-06 | at Elevated Temperatures Using a Rotational Viscometer |
| WOM | D4798M- | Standard Practice for Accelerated Weathering Test Conditions |
| | 11(2021) | and Procedures for Bituminous Materials (Xenon-Arc Method) |
| | ASTM | ASTM D1670/D1670M-11(2018): Standard Test Method for |
| | D1670/D1670M- | Failure End Point in Accelerated and Outdoor Weathering of |
| | 11(2018) | Bituminous Materials |

### Example 2—Non-Adhesion

Filled asphalt mixes and unfilled asphalt blends prepared according to the composition in sample S2b having differing particle sizes were prepared. The samples had the same contents but differing sizes of carbon black as per the description in table 4 below. Carbon black sizing was measured in unfilled blends of samples S3 and CS6 according to the following process.

Blends of samples S3 and CS6 were heated to 400-420° F. and coated to a thickness of 10 mils using a Gardco 5-50 mil square applicator. Sections of this drawdown coating can be cut to fit on a standard 25 mm×75 mm translucent glass slide. This slide was used in conjunction with an optical illuminated microscope, an AmScope MU1603 Digital camera, and AmScope AM software to take digital images of the sample at varying magnifications depending on particle size to analyze.

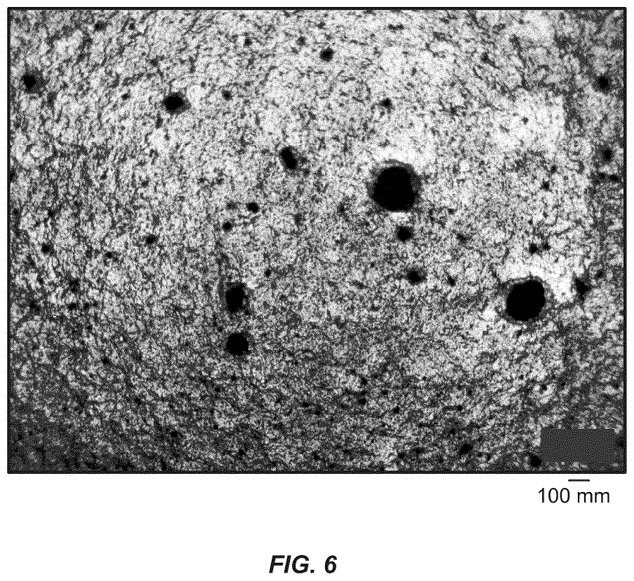

AmScope Software was used to take images and apply the appropriate scale (pixels to mm) using AmScope provided reference distance. In optical images the carbon black particles showed as fully black particles while the asphalt will illuminate as a deep orange color. An exemplary black and white recreate of the image can be found in FIG. 6. Images with scale reference were analyzed using FIJI image analysis software (Current version 2.9).

Samples S3 and CS6 underwent non-adhesion testing according to the following process. Samples were heated to 400-420° F. and applied to a glass mat. A metal film applicator was heated to 400-420° F. and a TQC Sheen Art. nr. AB4405 is heated to 125° C. and both were used to apply the asphalt mixes to both sides of the glass mat for a total coating density of 105-130 lb./SQ. The mats were allowed to cool to room temperature. Then the coated mats were cut into 3″×3″. pieces. Two of these squares were stacked on top of each other between two±0.20″ tolerance sheet metal pieces that are also 3″×3″. A weight or clamp was used to apply a pressure of approximately 1-1.2 PSI. Clamped/weighted samples were heated in an oven at 110° F. for 24 hours days. Samples were then removed and allowed to cool for 24 hrs. The weight was removed and samples are inspected visually for deformation and signs of obvious sticking.

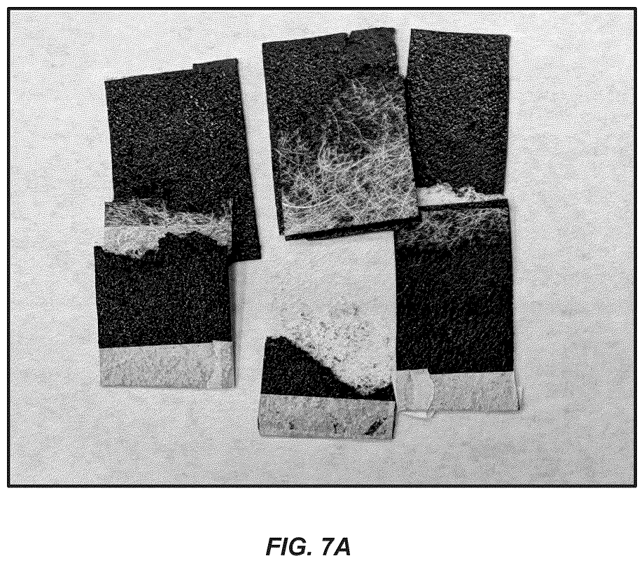

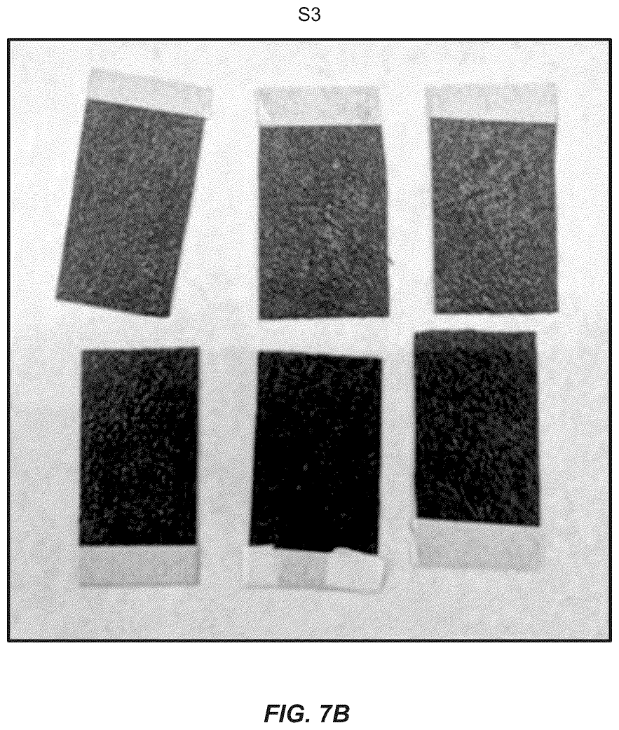

Samples are then peeled using a 3400 Series Instron load frame with 3″ hydraulic clamps at a rate of 2″ per minute. The force of separation is measured and noted as a non-adhesion factor (NAF) and reported below in table 4. Images of the separated shinglets can be found in FIGS. 7a and 7b.

TABLE 4

| Sample | S3 | CS6 |
|---|---|---|
| Average cross sectional area of carbon black | 20.9μ² | 746.6μ² |
| Standard deviation of cross sectional area of | 27.9μ² | 2916.8μ² |
| carbon black | | |
| Average diameter of carbon black | 6.62μ | 35.50μ |
| Standard deviation of diameter of carbon black | 4.18μ | 28.13μ |
| Average shingle NAF | 0.308 PLI | 1.120 PLI |
| Standard deviation of NAF | 0.040 PLI | 0.104 PLI |

What is claimed is:

1. A filled asphalt mix comprising:
an asphalt blend comprising:
asphalt,
a first polymer additive, and
carbon black; and
filler;
the filled asphalt mix having a softening point of at least 250° F., a penetration at 115° F. of less than or equal to 33 dmm, or an NAF of not greater than 1.0 PLI.

2. The mix of claim 1, wherein the asphalt comprises paving grade asphalt.

3. The mix of claim 2, wherein the paving grade asphalt comprises PG 64-22 asphalt.

4. The mix of claim 1, wherein the carbon black comprises virgin carbon black, reclaimed carbon black, recycled carbon black, or a combination thereof.

5. The mix of claim 1, wherein the carbon black comprises an average cross sectional area of no greater than 600μ² wherein the carbon black comprises an average diameter of no greater than 30μ.

6. The mix of claim 1, wherein the mix comprises an NAF of not greater than 1.0 PLI.

7. The mix of claim 1, wherein the asphalt mix comprises a softening point of at least 250° F. and no greater than 320° F.

8. The mix of claim 1, further comprising a penetration at 32° F. of no greater than 10 dmm and at least 1 dmm.

9. The mix of claim 1, further comprising a penetration at 77° F. of no greater than 20 dmm and at least 1 dmm.

10. The mix of claim 1, further comprising a penetration at 115° F. of no greater than 40 dmm and at least 21 dmm.

11. The mix of claim 1, further comprising a viscosity at 400° F. of at least 3600 cps and no greater than 10000 cps.

12. The mix of claim 1, further comprising a weatherability of at least 30 days.

13. The mix of claim 1, wherein the first polymer additive comprises an sbs polymer.

14. The mix of claim 1, further comprising a wax.

15. The mix of claim 14, wherein the wax comprises a recycled wax.

16. The mix of claim 15, wherein the wax comprises a paraffin wax, an alpha olefin wax, a polyamide wax, an ethylene vinyl acetate (EVA) wax, a polypropylene wax, a polyethylene wax, or a combination thereof.

17. The mix of claim 1, wherein the asphalt blend comprises at least 2.0 wt. % carbon black.

18. A method of preparing a filled asphalt mix according to claim 1,
providing the asphalt, polymer additive, and carbon black, and optionally a wax,
mixing the asphalt, polymer additive, and carbon black to prepare an asphalt blend,
providing a filler,
mixing the asphalt blend and the filler to prepare a filled asphalt mix.

19. A roofing shingle comprising:
a fiberglass mat;
an asphalt composition coating the fiberglass mat, the composition comprising the asphalt mix of claim 1.

20. A bundle of packaged roofing shingles according to claim 19.
